(19) United States
(12) Patent Application Publication
(10) Pub. No.: US 2010/0058369 A1
(43) Pub. Date: Mar. 4, 2010

(54) OPTICAL DISK APPARATUS

(76) Inventors: Yoshiyuki TANAKA, Kawasaki (JP); Ikuo Nishida, Ebina (JP); Hisahiro Miki, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/468,111

(22) Filed: May 19, 2009

(30) Foreign Application Priority Data
Aug. 29, 2008 (JP) 2008-221610

(51) Int. Cl. G11B 17/04

(52) U.S. Cl. 720/601; G9B/17.013

(57) ABSTRACT

The present invention provides an optical disk apparatus which allows for accurate centering of an optical disk regardless of its placed attitude and in which reliability of chucking operation has been improved, and the apparatus includes a first disk guide 41, a second disk guide 42, a third disk guide 43, and a fourth disk guide 44 for guiding the optical disk to a centering position, the guides being disposed in a chassis 20, and a cam member 47 disposed in the chassis 20, in which when the optical disk is guided to the centering position, the cam member 47 locks at least either the third disk guide 43 or the fourth disk guide 44 to restrain the optical disk from moving to an insertion direction thereof, then releasing the restraint at the time of chucking of the optical disk.

### INCORPORATION BY REFERENCE

The present application claims priority from Japanese application JP2008-221610 filed on Aug. 29, 2008, the content of which is hereby incorporated by reference into this application.

### BACKGROUND OF THE INVENTION

The present invention relates to an optical disk apparatus in which a slot for inserting/ejecting an optical disk is provided in a main body thereof, and in which the optical disk is chucked with a clamper to be rotated after it is loaded and then, information is recorded on the optical disk and/or information recorded on the optical disk is reproduced.

Conventionally, there is known an optical disk apparatus employing a slot-in system in which when an optical disk is inserted into a predetermined position, the optical disk is automatically loaded (transported) to a predetermined processing position. The optical disk apparatus employing this slot-in system is configured such that a damper is started to be inserted into a center hole of the optical disk inserted into the apparatus to then be chucked in a state where the disk is supported by disk guide members in four positions in a peripheral side surface of the optical disk, i.e., two positions in a front of a disk insertion direction, one position in a rear (back side) of the disk insertion direction, and one position in a lateral direction of the optical disk to be inserted. Among the above-described disk guide members, particularly, two disk guide members for supporting the optical disk in two positions of the disk peripheral side surface in the disk insertion direction support the optical disk in a state of being biased with springs, respectively.

In recent years, an optical disk apparatus employing a slot-in system to which both an optical disk of diameter 12 centimeters and that of diameter 8 centimeters are applicable has been introduced. Among such the optical disk apparatuses, for example, there is included an apparatus which provides a slot for inserting/ejecting an optical disk, a disk guide mechanism for guiding the optical disk inserted into the optical disk apparatus from the slot to an insertion direction, a drive unit for rotationally driving the optical disk, and a disk feed mechanism for feeding the optical disk inserted in the slot to the drive unit, and which is configured such that when the disk feed mechanism feeds a first optical disk, a feed amount thereof is reduced, while when it feeds a second optical disk smaller than the first one in diameter, a feed amount thereof is increased. In this optical disk apparatus, an insertion direction side of the optical disk is supported by an each tip of two eject arms, which are components of the disk feed mechanism when centering the optical disk. (For example, refer to JP-A-2006-127680).

Additionally, an optical disk apparatus has also been introduced in which a plurality types of cam grooves are formed in a main slider, and a disk guide unit opposed to a draw-in lever is displaced depending on an outer diameter of a disk as well as a rotational amount of the draw-in lever is switched by automatically selecting the cam groove for guiding a lever pin depending on the rotational amount of the draw-in lever at the time of inserting the disk according to the outer diameter of the disk. (For example, refer to JP-A-2007-207302).

Further, an optical disk apparatus has also been introduced in which a lever member is provided for guiding a side surface of an optical disk, for loading the optical disk in such a position that a center of a turntable on which this optical disk is chucked is identical to that of the disk, or for unloading it in an opposite direction to a loading direction, and in which the lever member operates so as to have different trajectories in each case according to a diameter of the optical disk and thereby the optical disks of various diameters can be loaded or unloaded. (For example, refer to JP-A-2007-220277).

### BRIEF SUMMARY OF THE INVENTION

However, in the optical disk apparatus described in JP-A-2006-127680, the each eject arm rotates to thereby guide the optical disk to a centering position when centering the optical disk, but these eject arms are not devised so as to prevent the optical disk from moving nearer an optical disk insertion direction than the centering position, so that there is a possibility of impairing centering reliability. Particularly, for example, in the case of an optical disk apparatus placed in a vertical attitude, i.e., placed with a right back side or a left back side in an optical disk insertion direction being down, the inserted optical disk is likely to move to a lower side of the optical disk apparatus due to its own weight, so that there is also a possibility that normal chucking with a damper cannot be performed.

Additionally, similarly, in the optical disk apparatuses described in JP-A-2007-207302 and JP-A-2007-220277, it is not devised to prevent the optical disk from moving nearer an optical disk insertion direction than a centering position, so that there is a possibility of impairing centering reliability.

The present invention is made in view of such situations, and it aims at providing an optical disk apparatus which allows for accurate centering of an optical disk regardless of its placed attitude and in which reliability of chucking operation has been improved.

In order to achieve the above-described object, the present invention is an optical disk apparatus for chucking an optical disk inserted into a housing and guided to a centering position to then record or reproduce information, in which there are provided a chassis disposed in the housing, a first disk guide for supporting a first position of the optical disk to then guide the optical disk to the centering position, the guide being disposed on the chassis, a second disk guide for supporting a second position spaced apart from the first position of the optical disk to then guide the optical disk to the centering position, the guide being disposed on the chassis, a third disk guide for supporting a third position nearer an insertion direction than the first position of the optical disk guided by the first disk guide and the second disk guide and then guiding the optical disk to the centering position along with the first disk guide and the second disk guide, the guide being disposed on the chassis, a fourth disk guide for supporting a fourth position nearer the insertion direction than the second position of the optical disk guided by the first disk guide and the second disk guide, the position also being spaced apart from the third position, and then guiding the optical disk to the centering position along with the first disk guide and the second disk guide, the guide being disposed on the chassis, and a cam member disposed on the chassis, and in which when the optical disk is guided to the centering position, the cam member locks at least either the third disk guide or the fourth disk guide to restrain the optical disk from moving to the insertion direction thereof, and then it releases the restraint when chucking of the optical disk is completed.

An optical disk apparatus according to the present invention allows for accurate centering of an optical disk regardless of its placed attitude, thus enabling to improve reliability of chucking operation.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is an external view of an optical disk apparatus according to an embodiment of the present invention;

FIG. 2 is an exploded view of the optical disk apparatus by a unit according to the present embodiment;

FIG. 3 is a plane view of a loading unit seen from a top in an initial state of the optical disk apparatus according to the present embodiment;

FIG. 4 is a bottom view of the loading unit shown in FIG. 3;

FIG. 5 is a plane view showing a state where a traverse unit is disposed in the loading unit shown in FIG. 3;

FIG. 6 is a bottom view showing a state where the traverse unit and a circuit board are disposed in the loading unit shown in FIG. 4;

FIG. 7 is a partial exploded perspective view showing a state where a chassis, a third disk guide, and a fourth disk guide are eliminated from the unit shown in FIG. 5;

FIG. 8 is a bottom view showing a state where the circuit board is eliminated from the unit shown in FIG. 6;

FIG. 9 is a bottom view showing a state where a cam member is eliminated from the unit shown in FIG. 8;

FIG. 10 is a partial exploded perspective view showing a state where the cam member is eliminated from the unit shown in FIG. 7;

FIG. 11 is a partial enlarged bottom view of the unit shown in FIG. 9;

FIG. 12 is a bottom view showing a state where the part of the unit shown in FIG. 11 is further enlarged and some parts thereof are removed;

FIG. 13 is a bottom view showing a state where the part of the unit shown in FIG. 11 is further enlarged;

FIG. 14 is a bottom view showing a state where the part of the unit shown in FIG. 11 is further enlarged;

FIG. 15 is a bottom view showing a state where the part of the unit shown in FIG. 8 is further enlarged;

FIG. 16 is a partial view of the unit shown in FIG. 7 seen from an insertion direction;

FIG. 17 is a partial view of the unit shown in FIG. 7 seen from a left side;

FIG. 18 is a perspective view of the cam member, which is a component of the optical disk apparatus according to the present embodiment;

FIG. 19 is a perspective view of the cam member, which is a component of the optical disk apparatus according to the present embodiment;

FIG. 20 is a perspective view of a function lever, which is a component of the optical disk apparatus according to the present embodiment;

FIG. 21 is a perspective view of a function lever, which is a component of the optical disk apparatus according to the present embodiment;

FIG. 22 is a perspective view of a function lever, which is a component of the optical disk apparatus according to the present embodiment;

FIG. 23 is a bottom view of the circuit board, which is a component of the optical disk apparatus according to the present embodiment;

FIG. 24 is a plane view showing a top surface of the circuit board shown in FIG. 23;

FIG. 25 is a plane view seen from the top without a top cover showing a state where an optical disk of diameter 12 centimeters is being inserted into the optical disk apparatus according to the present embodiment;

FIG. 26 is a bottom view showing a state where a bottom case and the circuit board are eliminated from the state shown in FIG. 25;

FIG. 27 is a partial enlarged bottom view showing a state where the cam member is eliminated from the state shown in FIG. 26;

FIG. 28 is a further enlarged partial bottom view of the state shown in FIG. 27;

FIG. 29 is a further enlarged partial bottom view of the state shown in FIG. 26;

FIG. 30 is a plane view showing a state where the optical disk is further inserted in the state shown in FIG. 25 to thereby start a loading motor;

FIG. 31 is a bottom view showing a state where the bottom case and the circuit board are eliminated from the state shown in FIG. 30;

FIG. 32 is a partial enlarged bottom view showing a state where the cam member is eliminated from the state shown in FIG. 31;

FIG. 33 is a further enlarged partial bottom view of the state shown in FIG. 32;

FIG. 34 is a further enlarged partial bottom view of the state shown in FIG. 32 and the state after starting loading motor;

FIG. 35 is a plane view showing a state where the optical disk is further inserted in the state shown in FIG. 30 and then it is centered;

FIG. 36 is a bottom view showing a state where the bottom case and the circuit board are eliminated from the state shown in FIG. 35;

FIG. 37 is a partial enlarged bottom view showing a state where the cam member is eliminated from the state shown in FIG. 36;

FIG. 38 is a partial view of the unit shown in FIG. 35 seen from the insertion direction;

FIG. 39 is a partial view of the unit shown in FIG. 35 seen from the left side;

FIG. 40 is a plane view seen from the top without the top cover showing a state where the optical disk of diameter 12 centimeters can be played;

FIG. 41 is a partial exploded perspective view from a Y direction showing a state where the chassis, the third disk guide, and the fourth disk guide are eliminated from the unit shown in FIG. 40;

FIG. 42 is a bottom view showing a state where the bottom case and the circuit board are eliminated from the state shown in FIG. 40;

FIG. 43 is a partial enlarged bottom view showing a state where the cam member is eliminated from the state shown in FIG. 42;

FIG. 44 is a partial enlarged bottom view of the unit shown in FIG. 42;

FIG. 45 is a partial view of the unit shown in FIG. 40 seen from the insertion direction;

FIG. 46 is a partial view of the unit shown in FIG. 40 seen from the left side;

FIG. 47 is a plane view seen from the top without the top cover showing a state where the optical disk of diameter 12 centimeters is ejected;

FIG. 48 is a bottom view showing a state where the bottom case and the circuit board are eliminated from the state shown in FIG. 47;

FIG. 49 is a partial enlarged bottom view showing a state where the cam member is eliminated from the state shown in FIG. 48;

FIG. 50 is a further enlarged partial bottom view of the state shown in FIG. 49;

FIG. 51 is a plane view seen from the top without the top cover showing a state where an optical disk of diameter 8 centimeters is being inserted into the optical disk apparatus according to the present embodiment;

FIG. 52 is a plane view showing a state where the optical disk is further inserted in the state shown in FIG. 51 to thereby start the loading motor;

FIG. 53 is a bottom view showing a state where the bottom case and the circuit board are eliminated from the state shown in FIG. 52;

FIG. 54 is a partial enlarged bottom view showing a state where the cam member is eliminated from the state shown in FIG. 53;

FIG. 55 is a further enlarged partial bottom view of the state shown in FIG. 54;

FIG. 56 is a partial enlarged bottom view of FIG. 59;

FIG. 57 is a plane view showing a state where the optical disk is further inserted in the state shown in FIG. 52 and then it is centered;

FIG. 58 is a partial exploded perspective view showing a state where the chassis, the third disk guide, and the fourth disk guide are eliminated from the unit shown in FIG. 57;

FIG. 59 is a bottom view showing a state where the bottom case and the circuit board are eliminated from the state shown in FIG. 57;

FIG. 60 is a partial enlarged bottom view showing a state where the cam member is eliminated from the state shown in FIG. 59;

FIG. 61 is a plane view seen from the top without the top cover showing a state where the optical disk of diameter 8 centimeters can be played;

FIG. 62 is a bottom view showing a state where the bottom case and the circuit board are eliminated from the state shown in FIG. 61;

FIG. 63 is a partial enlarged bottom view of the state shown in FIG. 62;

FIG. 64 is a plane view seen from the top without the top cover showing a state where the optical disk of diameter 8 centimeters is ejected;

FIG. 65 is a bottom view showing a state where the bottom case and the circuit board are eliminated from the state shown in FIG. 64; and

FIG. 66 is a partial enlarged bottom view showing a state where the cam member is eliminated from the state shown in FIG. 65.

### DETAILED DESCRIPTION OF THE INVENTION

Next, an optical disk apparatus according to a preferred embodiment of the present invention will be explained with reference to drawings. It is to be noted that the embodiment described hereinafter is an illustration for describing the present invention, and does not limit the present invention only thereto. Hence, the present invention can be carried out with various modes unless departing from the gist thereof.

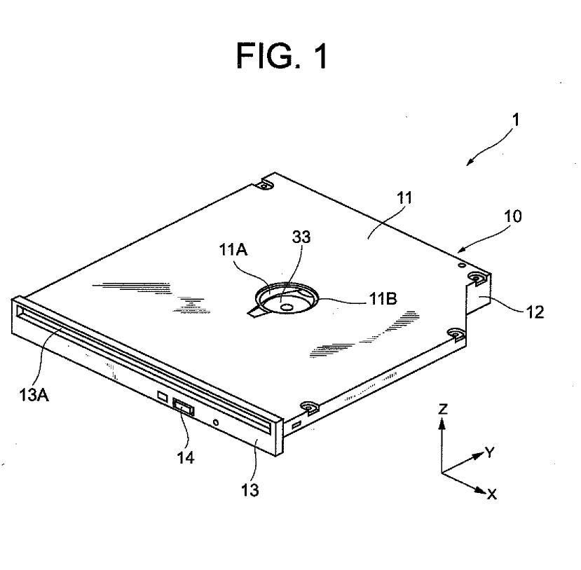

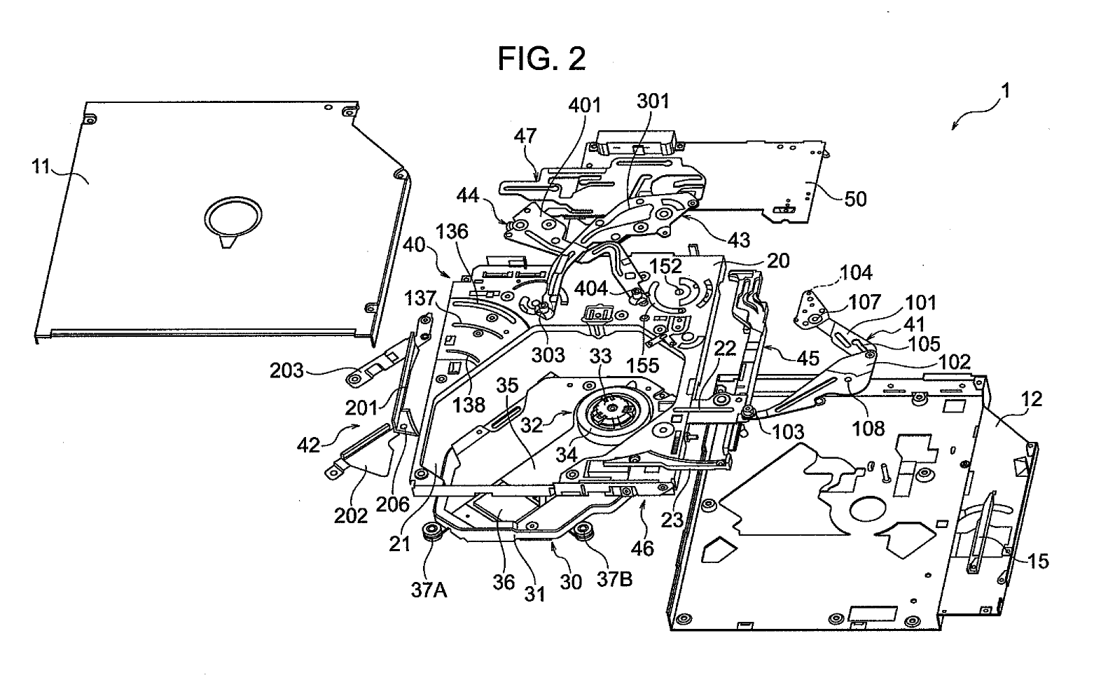

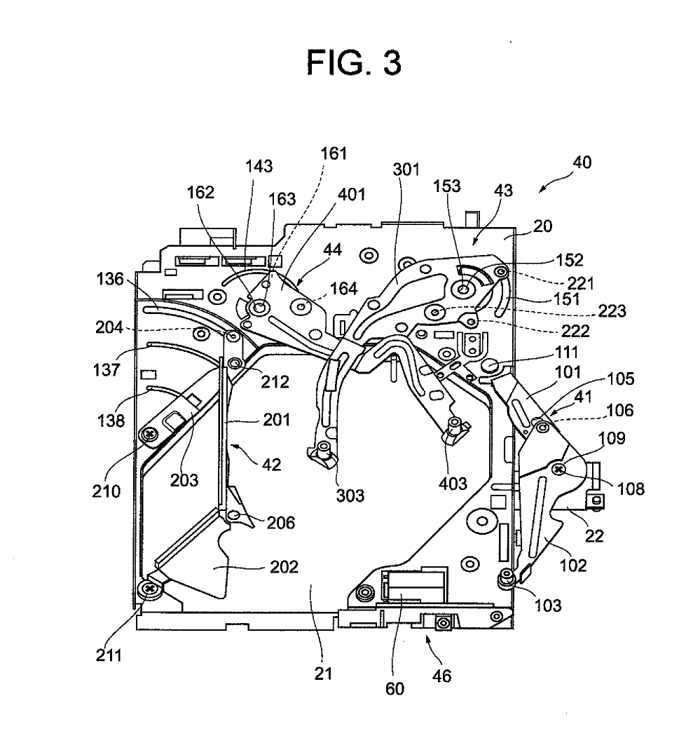

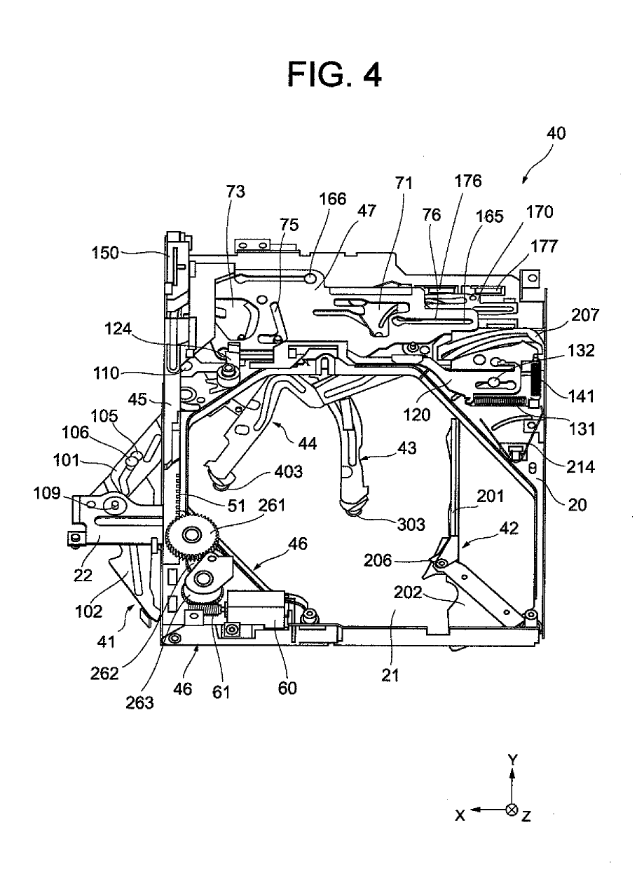

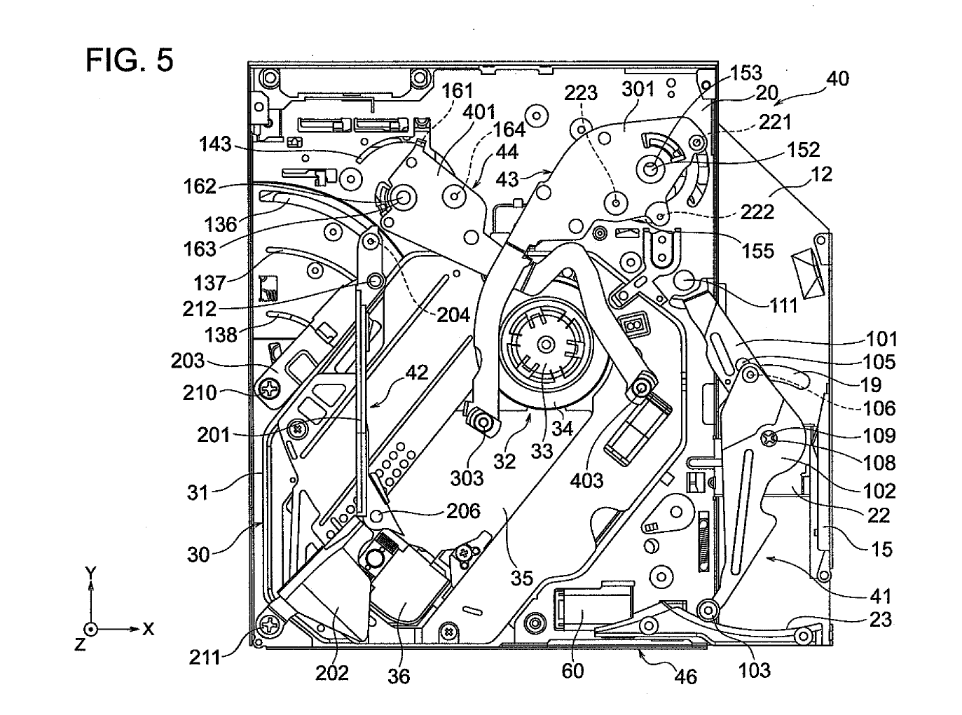

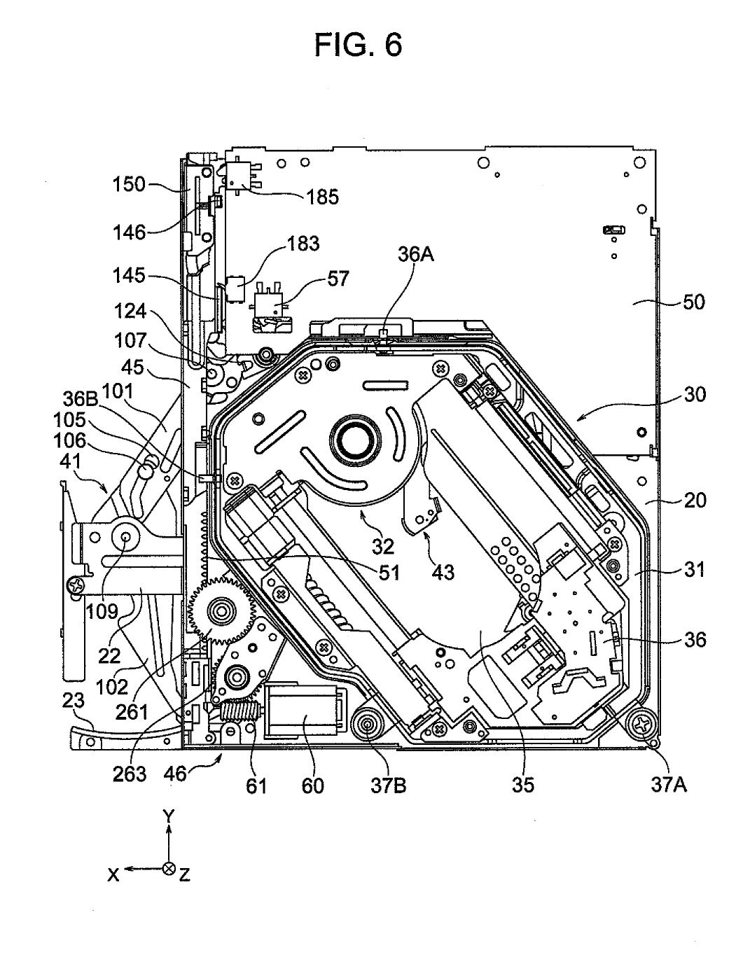

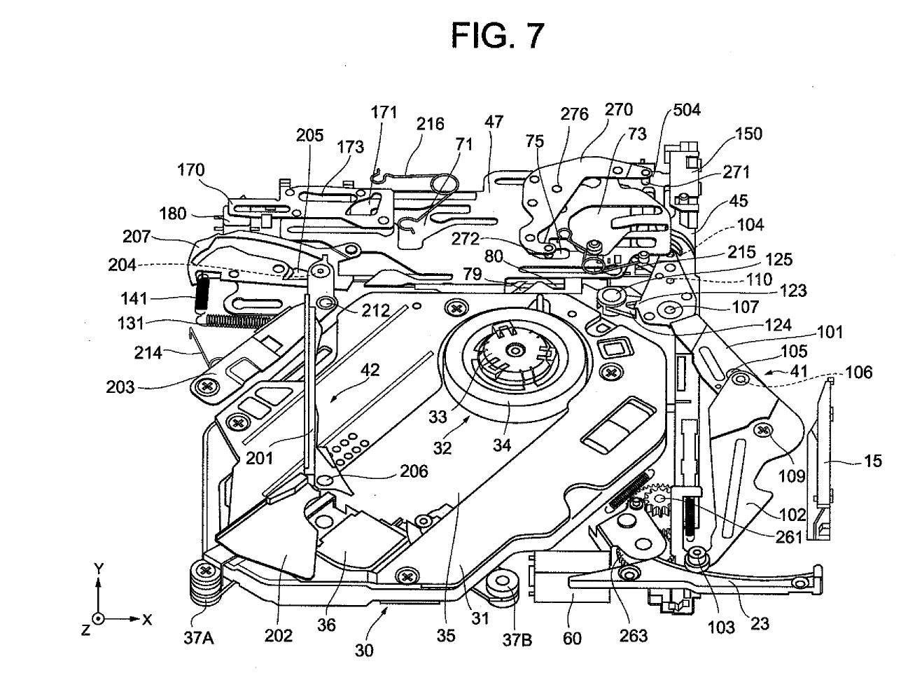

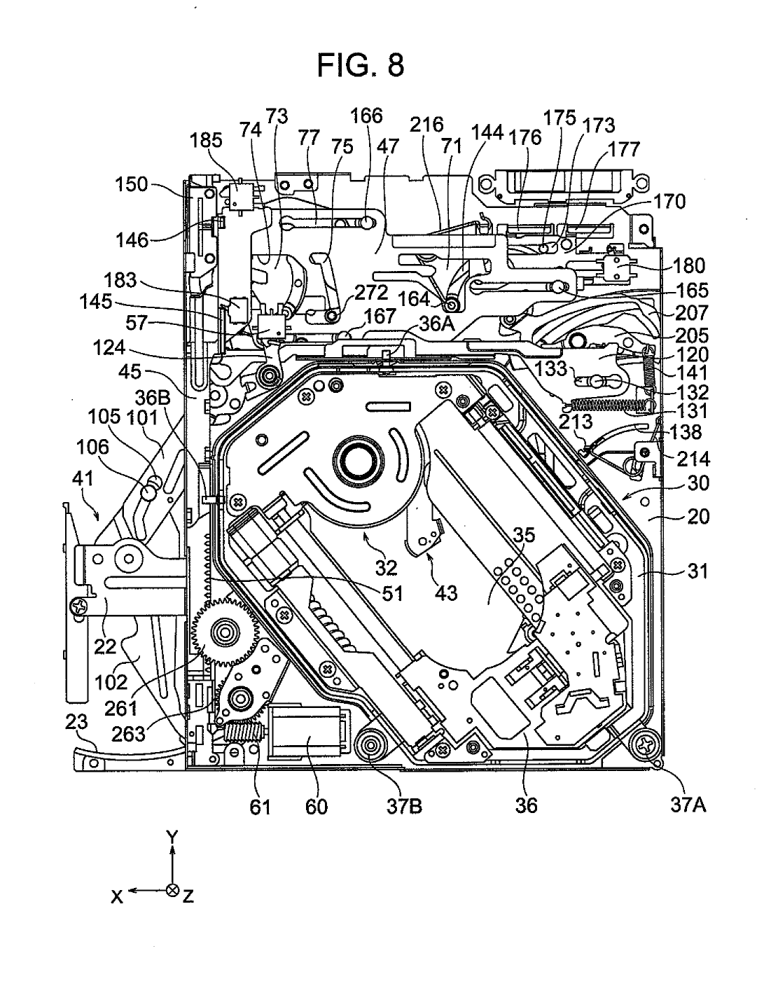

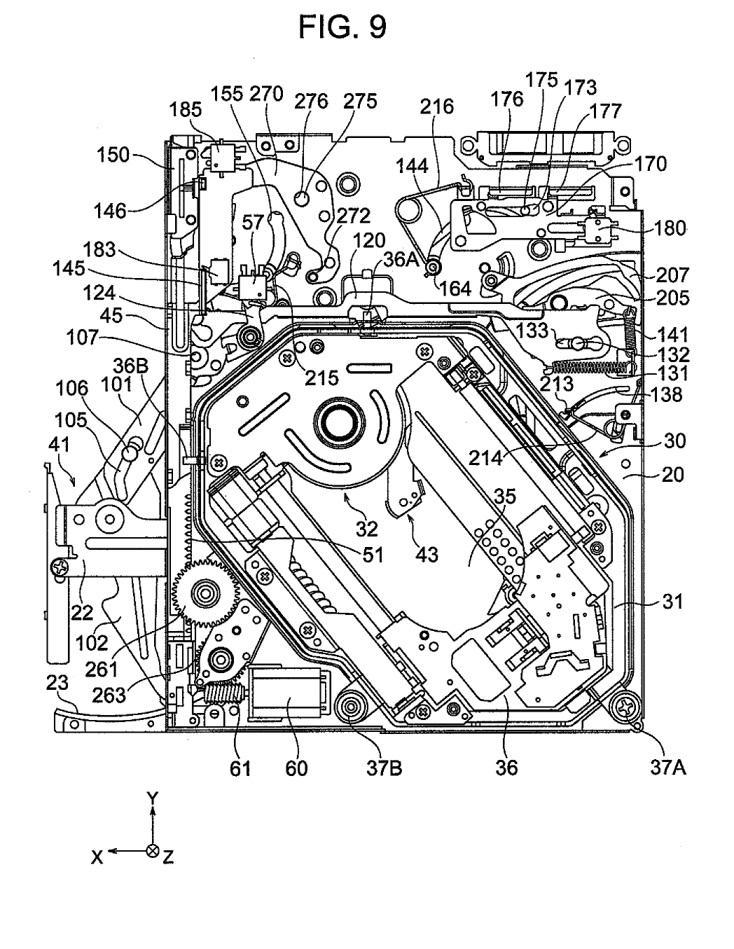

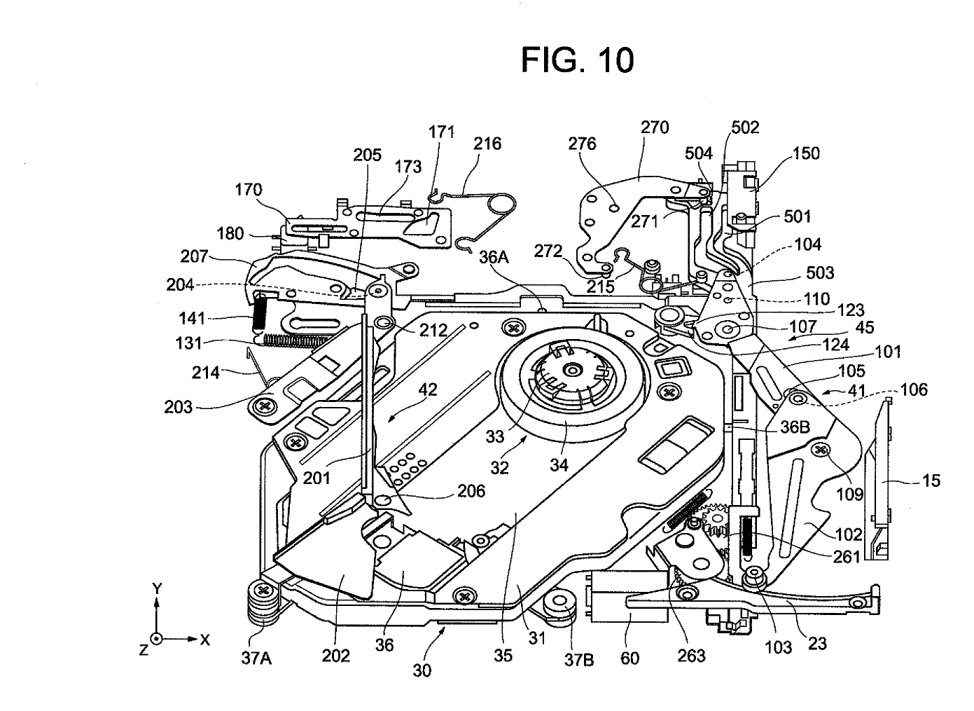

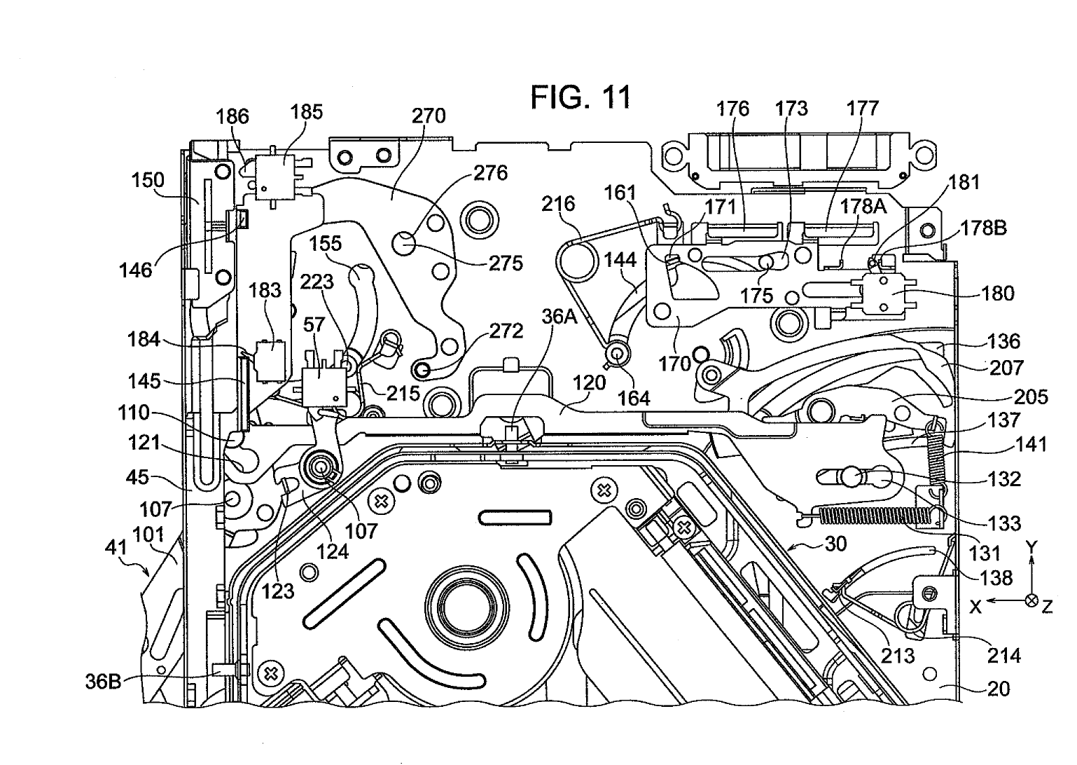

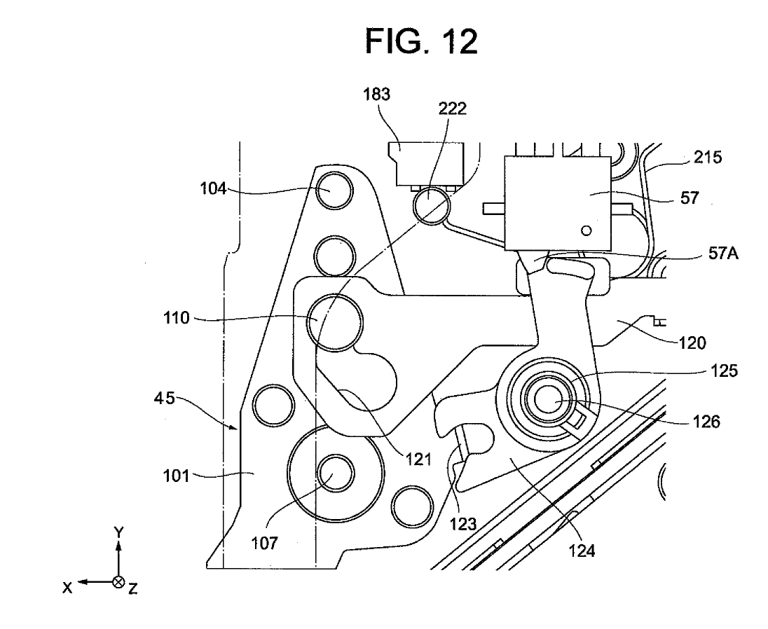

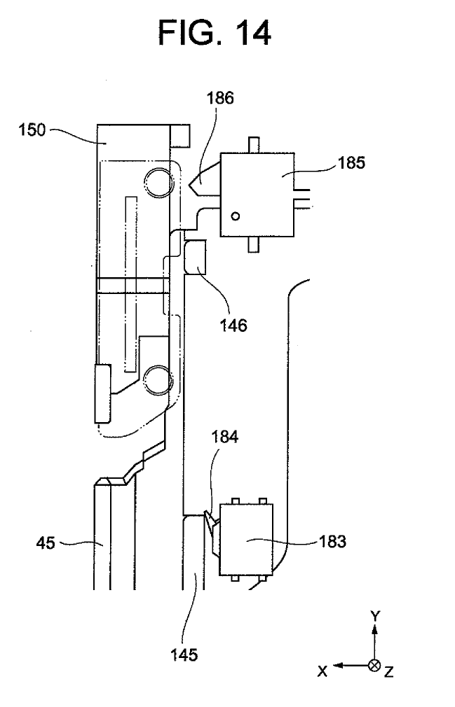

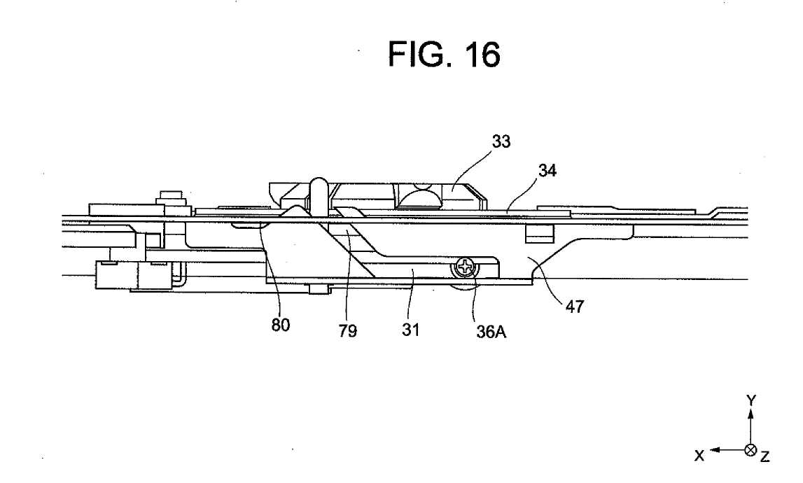

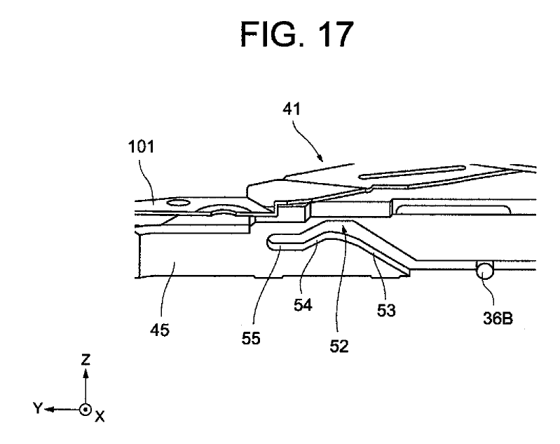

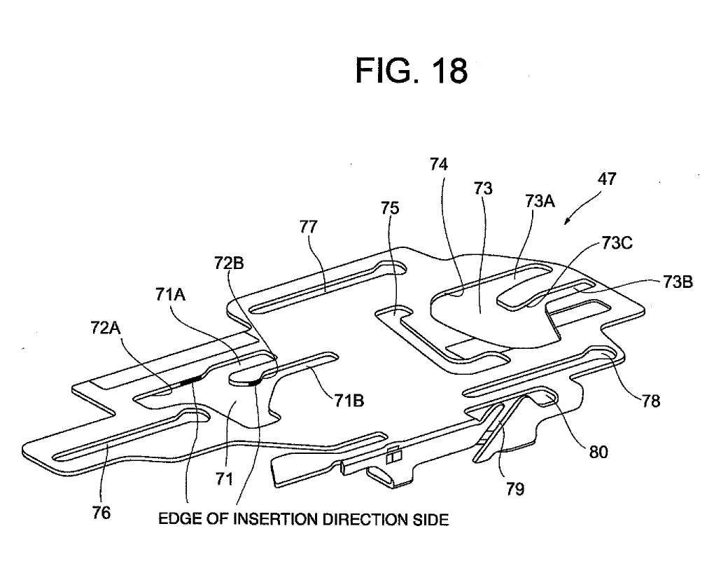

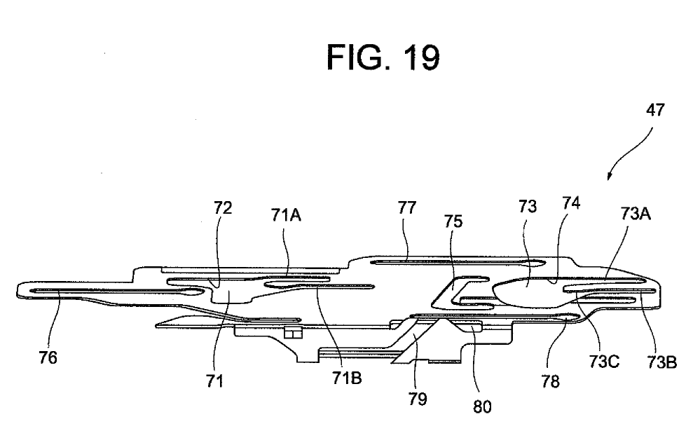

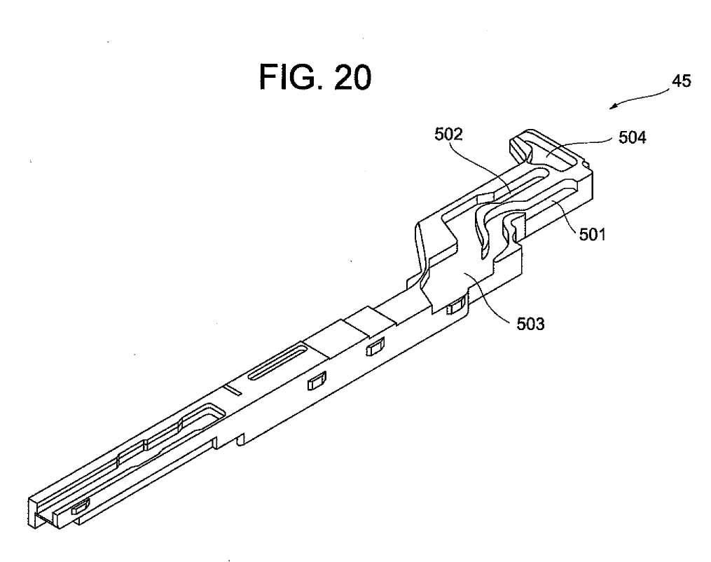

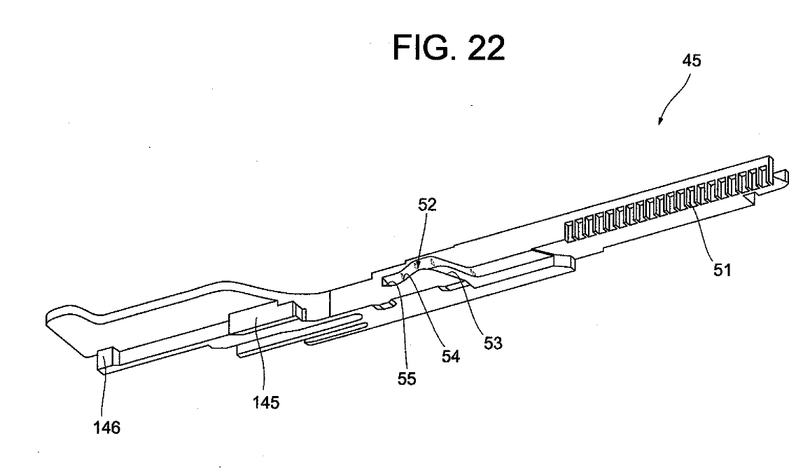

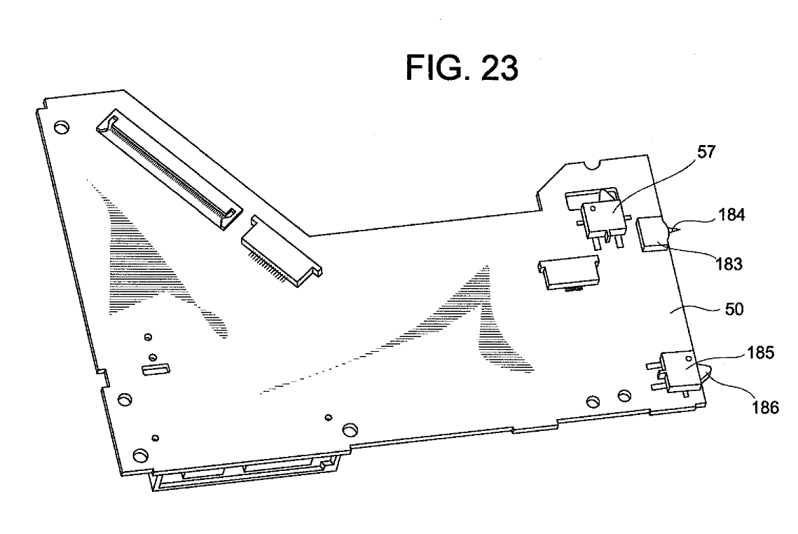

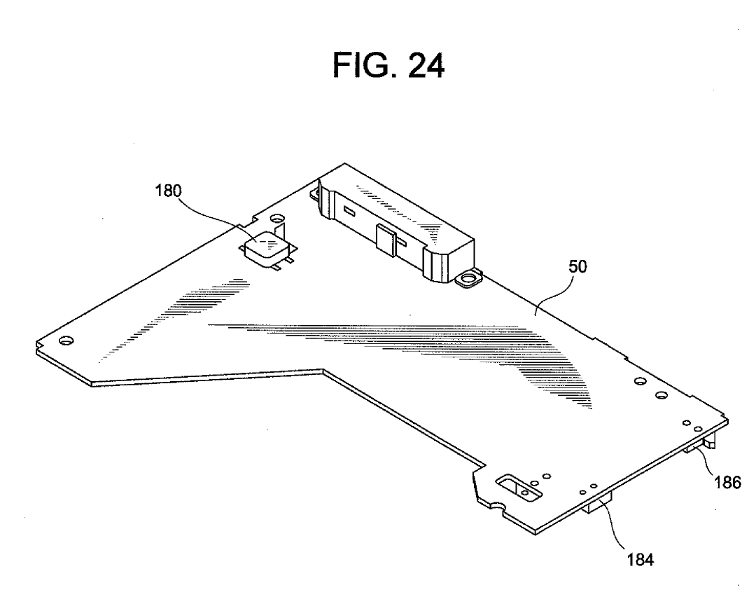

FIG. 1 is an external view of an optical disk apparatus according to an embodiment of the present invention; FIG. 2 is an exploded view of the optical disk apparatus by a unit according to the present embodiment; FIG. 3 is a plane view of a loading unit seen from a top in an initial state of the optical disk apparatus according to the present embodiment; FIG. 4 is a bottom view of the loading unit shown in FIG. 3; FIG. 5 is a plane view showing a state where a traverse unit is disposed in the loading unit shown in FIG. 3; FIG. 6 is a bottom view showing a state where the traverse unit and a circuit board are disposed in the loading unit shown in FIG. 4; FIG. 7 is a partial exploded perspective view showing a state where a chassis, a third disk guide, and a fourth disk guide are eliminated from the unit shown in FIG. 5; FIG. 8 is a bottom view showing a state where the circuit board is eliminated from the unit shown in FIG. 6; FIG. 9 is a bottom view showing a state where a cam member is eliminated from the unit shown in FIG. 8; FIG. 10 is a partial exploded perspective view showing a state where the cam member is eliminated from the unit shown in FIG. 7; FIG. 11 is a partial enlarged bottom view of the unit shown in FIG. 9; FIGS. 12 to 15 are bottom views showing a state where the part of the unit shown in FIG. 11 and FIG. 8 is further enlarged; FIG. 16 is a partial view of the unit shown in FIG. 7 seen from an insertion direction; FIG. 17 is a partial view of the unit shown in FIG. 7 seen from a left side; FIGS. 18 and 19 are perspective views of the cam member, which is a component of the optical disk apparatus according to the present embodiment; FIGS. 20 to 22 are perspective views of a function lever, which is a component of the optical disk apparatus according to the present embodiment; FIG. 23 is a bottom view of the circuit board, which is a component of the optical disk apparatus according to the present embodiment; FIG. 24 is a plane view showing a top surface of the circuit board shown in FIG. 23. It is to be noted that thickness, size, enlargement/reduction rate, etc. of each member in the each drawing are illustrated differently from those of real things in order to clarify the explanation herein.

Additionally, in the optical disk apparatus according to the present embodiment, a “top” denotes a side having the optical disk loaded, while a “lower side” or a “bottom” denotes an opposite side thereof. Further, an “insertion direction” denotes a direction into which the optical disk is inserted, while an “ejection direction” denotes a direction to which it is ejected. Still further, a “right” denotes a right side toward the insertion direction with the side having the optical disk loaded being up, the side being in a substantially vertical direction in respect to the optical disk insertion direction, while a “left” denotes a left side toward the insertion direction. Yet still further, an arrow X direction illustrated in the drawings used in the present invention indicates a “right direction”, and therefore, a left direction denotes a “−X direction”, an arrow Y direction indicates the “insertion direction”, and therefore, the ejection direction denotes a “−Y direction”, and an arrow Z direction an “upper direction”, and therefore, a lower direction (bottom surface side) denotes a “−Z direction.”

It is to be noted that the right and left directions and the upper and lower directions of the optical disk apparatus look inverted seen from the top compared with the case seen from the bottom. Hence, in order to avoid confusion, the right and left directions are indicated using terms “−X direction” and “X direction” as much as possible, while the upper and lower directions are indicated using the terms “Z direction” and “−Z direction” as much as possible.

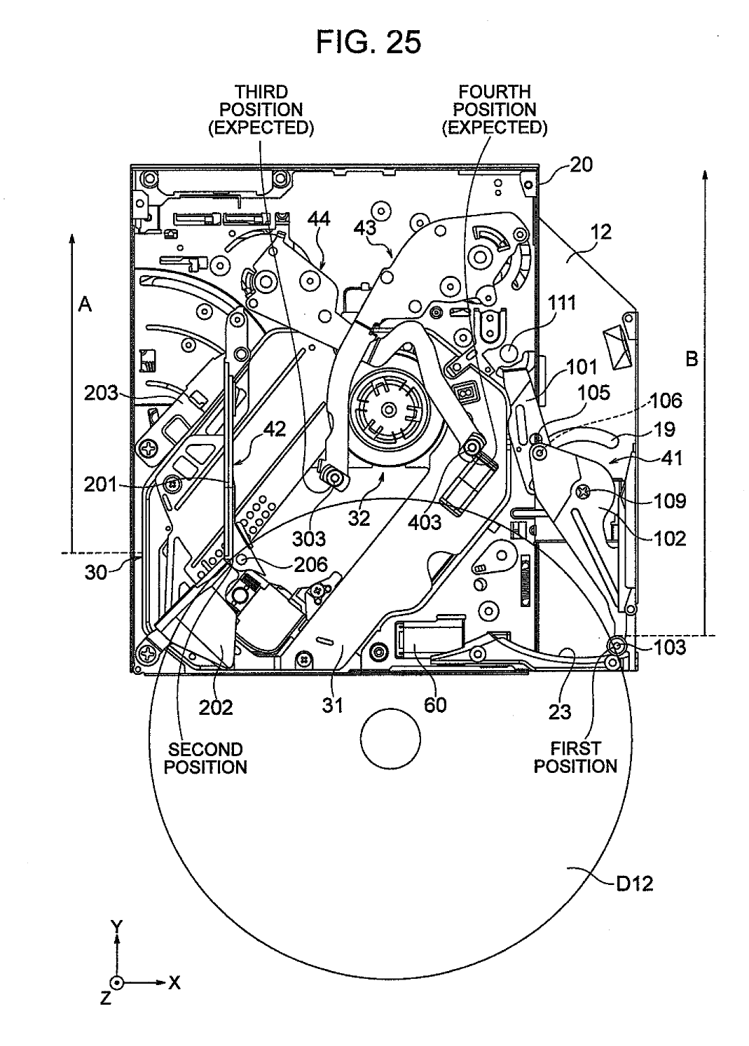

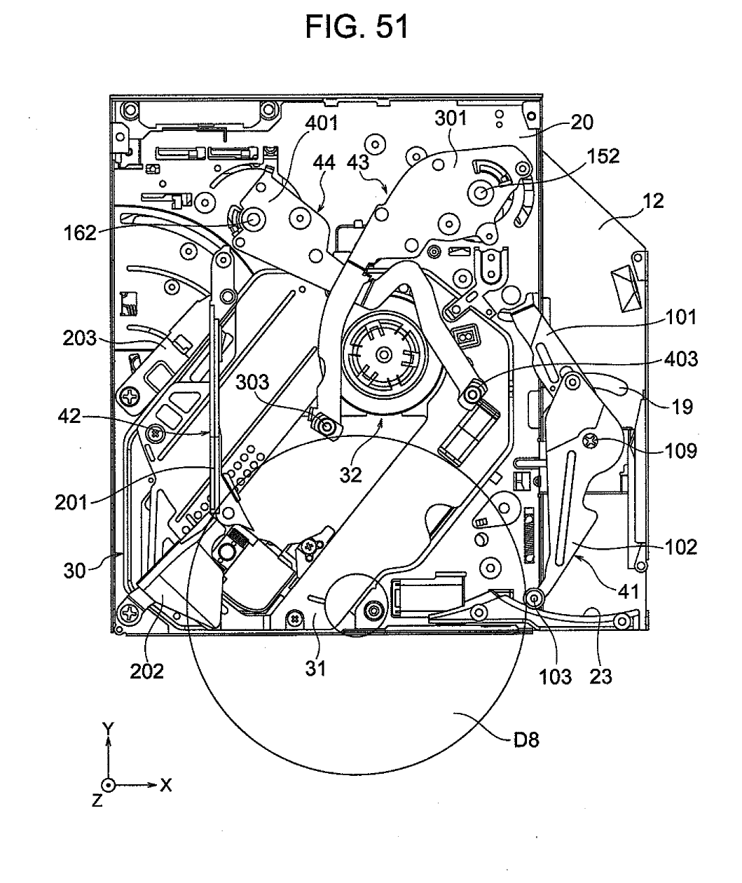

As shown in FIG. 1, an optical disk apparatus 1 according to the present embodiment is an optical disk apparatus employing a thin slot-in system that can use both an optical disk D12 of diameter 12 centimeters (for example, refer to FIG. 25) and an optical disk D8 of diameter 8 centimeters (for example, refer to FIG. 51) as a recording medium. This optical disk apparatus 1 is configured to provide a top cover 11 for covering a top surface of the apparatus (Z direction), a bottom case 12 for covering a bottom surface thereof (−Z direction), and a front panel 13 disposed in a front of the apparatus (−Y direction).

Substantially in a center of the top cover 11, there is formed a hole 11A into which a clamper 33 described hereinafter penetrates at the time of chucking of the optical disk D12 (D8). In an upper periphery of this hole 11A, a circular concave portion 11B is formed. At a right (X direction) end of the bottom case 12, a guide member 15 (for example, refer to FIG. 5) is disposed for guiding a part of a periphery of the optical disk D12 of diameter 12 centimeters. On the front panel 13, an opening 13A is formed for inserting and ejecting the optical disk D12 (D8) in and from a housing 10. Additionally, on the front panel 13, an eject button 14 is disposed for ejecting the optical disk D12 (D8) from the housing 10.

Next, various units and parts disposed in this housing 10 will be explained. As shown in FIGS. 2 to 11, in the housing 10, there are disposed a chassis 20 constituting a base of the apparatus, a traverse unit 30 supported by the chassis 20, a loading unit 40 supported by the chassis 20, a circuit board 50 for controlling drive of these units, etc.

The traverse unit 30 is disposed in an internal space 21 (for example, refer to FIG. 3) demarcated by the chassis 20, and provides a mechanical deck member 31 constituting a base of the traverse unit 30. On this mechanical deck member 31, there is formed an opening 35 opened obliquely from an end in the ejection direction and also the −X direction to an end in the insertion direction and also the X direction when disposed in the housing 10.

At an end of the opening 35 in the insertion direction and also the X direction, there are disposed a spindle motor 32 for rotationally driving the optical disk D12 (D8), a damper 33 for being inserted into a center hole formed on the optical disk D12 (D8) to then chuck the optical disk D12 (D8), the damper being disposed on an upper portion of the spindle motor 32, and a turntable 34 for supporting an information recording surface of the optical disk D12 (D8) in a state where the damper 33 has been inserted into the center hole of the optical disk D12 (D8), the turntable being disposed on a periphery of the damper 33. Additionally, at the opening 35, an optical pickup 36 is disposed for moving between the end in the ejection direction and also the −X direction and the spindle motor 32. This optical pickup 36 moves to a radial direction of the optical disk D12 (D8), and then irradiates the information recording surface of the optical disk D12 (D8) with a laser beam to thereby record information or reproduce information recorded on the information recording surface. Note that on the mechanical deck member 31, a movement mechanism (not shown), etc. for moving the optical pickup 36 are disposed.

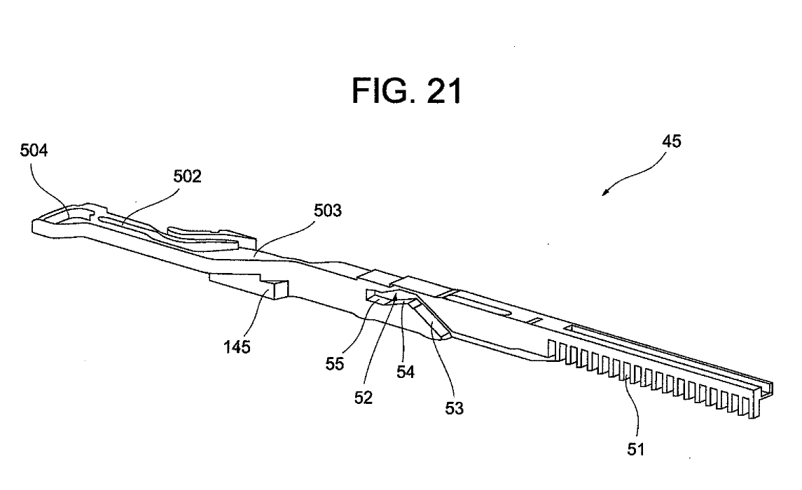

Further, substantially in a center of a tip of the mechanical deck member 31 in the insertion direction, a pin 36A (for example, refer to FIG. 6) is disposed, and on the tip of the mechanical deck member 31 in the insertion direction and also a side surface thereof in the X direction (for example, refer to FIG. 6), a pin 36B is disposed. Still further, at the tip of the mechanical deck member 31 in the ejection direction and also the −X direction, and at the tip thereof in the ejection direction and also the X direction, dampers 37A and 37B (for example, refer to FIG. 2) are disposed, respectively. The pin 36A is inserted into an inclined hole 79 and a horizontal hole 80 that are formed on an end surface of a cam member 47 in the ejection direction (for example, refer to FIG. 18), which is a configuration requirement of a loading unit 40 explained in detail hereinafter, and then, it relatively moves in the inclined hole 79 and the horizontal hole 80. The pin 36B is inserted into an inclined hole 52 formed on a side surface of a function lever 45 (for example, refer to FIG. 21) in the −X direction, which is a configuration requirement of the loading unit 40 explained in detail hereinafter, and then, it relatively moves in the inclined hole 52. Subsequently, by the relative movement of these pins 36A and 36B, the traverse unit 30 moves to a vertical direction (Z and −Z directions) with respect to a reference surface in the housing 10, chucks the optical disk D12 (D8) with the elevated damper 33, and lowers the damper 33 after chucking, thus making the optical disk D12 (D8) rotatable for a recording or a reproducing operation. The dampers 37A and 37B are attached to the chassis 20, follow the relative movement of the pins 36A and 36B, and absorb vibration generated by a vertical (Z and −Z directions) movement of the traverse unit 30, thus making the traverse unit 30 perform the stable vertical movement.

The elevated damper 33 is inserted into the center hole of the optical disk D12 (D8) and supports the optical disk D12 (D8) in the radial direction thereof, and subsequently, it is further elevated and a part of the tip thereof penetrates the hole 11A. At this time, a surface around the center hole of the optical disk D12 (D8) is pressed against a bottom surface (−Z direction) of the concave portion 11B, and by the resulting reaction force, the damper 33 penetrates into a predetermined position in the center hole of the optical disk D12 (D8), thus the optical disk D12 (D8) being chucked to the damper 33.

The loading unit 40 provides a first disk guide 41 rotatably disposed at an end of the chassis 20 in the X direction, a second disk guide 42 disposed at an end of the chassis 20 in the −X direction movably in a horizontal direction (−X and X directions), a third disk guide 43 and a fourth disk guide 44 disposed at a back side of the chassis 20 in the insertion direction, these guides intersecting each other, the function lever 45 disposed at the end of the chassis 20 in the X direction, a drive unit 46 for moving the function lever 45 to the insertion direction and the ejection direction, the unit being disposed at the end of the chassis 20 in the X direction and also the ejection direction, and the cam member 47 for moving to the horizontal direction (−X and X directions) according to the movement of the function lever 45, the member being disposed at the back side of the chassis 20 in the insertion direction.

The first disk guide 41 guides the optical disk D12 (D8) to a centering position while supporting a first position of a peripheral end of the optical disk D12 (D8). Here, the centering position is a position where the optical disk D12 (D8) loaded in the optical disk apparatus 1 is positioned so that when the damper 33 is inserted into the center hole of the optical disk D12 (D8), the center hole is identical to a center of the damper 33 in an upper side of the damper 33 (Z direction). This first disk guide 41 has an action lever 101 located in an insertion direction, an insertion arm 102 connected to an ejection direction of the action lever 101, and an insertion roller 103 for supporting the first position of a peripheral end surface of the optical disk D12 (D8), the roller being disposed at a tip of the insertion arm 102 in the ejection direction.

At the end of a bottom surface of the action lever 101 in the insertion direction, a substantially cylindrical pin 104 (for example, refer to FIG. 7) is set up toward the −Z direction. This pin 104 is movably inserted into cam grooves 501 and 502 (for example, refer to FIG. 20) formed on a top surface of the end of the function lever 45 (Z direction) explained in detail hereinafter in the insertion direction, and a merging portion 503 into which these grooves are merged. At an end of the bottom surface of the action lever 101 in the ejection direction, there is formed an elongate hole 105 through which a pin 106 (for example, refer to FIG. 4) movably penetrates, the pin being formed at an end of the bottom surface of the insertion arm 102, explained in detail hereinafter, in the insertion direction. Subsequently, this pin 106 is movably inserted into a substantially circular hole 19 (for example, refer to FIG. 5) formed in the bottom case 12. Substantially in a center of the action lever 101, there is formed a hole 107 (for example, refer to FIG. 7) through which a pin 111 attached to the chassis 20 penetrates, and the action lever 101 is rotatable with the pin 111 penetrating the hole 107 being as a fulcrum.

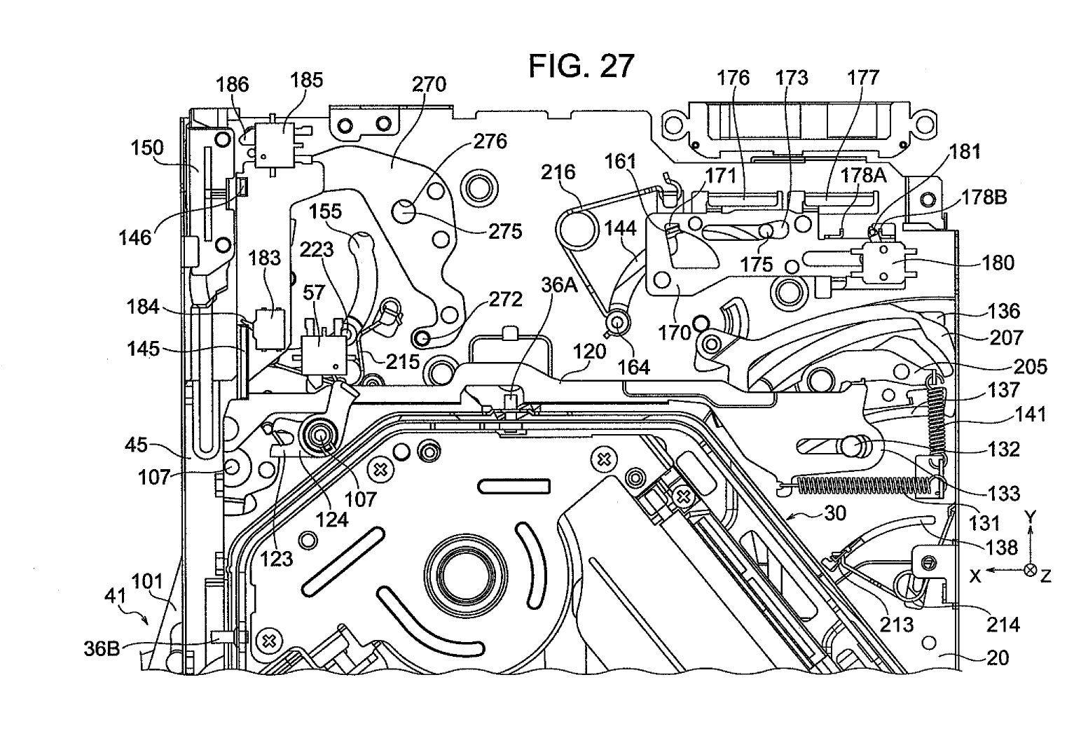

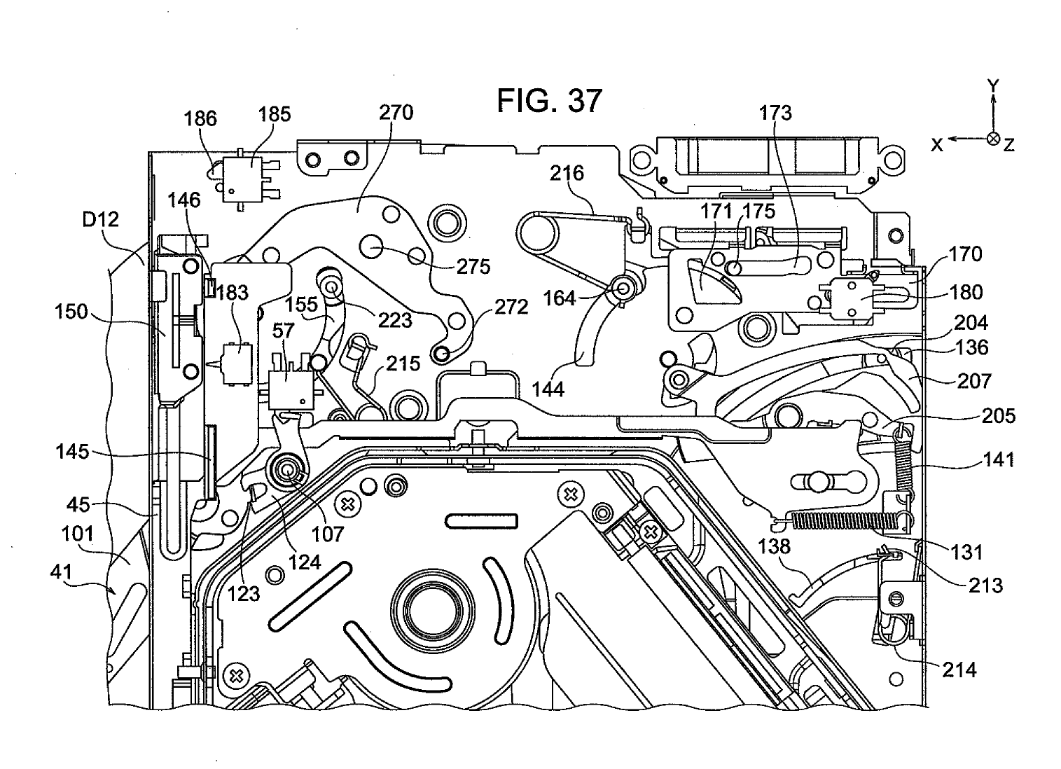

Additionally, between a position on which the pin 104 is formed and a position on which the hole 107 is formed, the positions being on the bottom surface of the action lever 101, a substantially cylindrical pin 110 is set up toward the −Z direction (for example, refer to FIG. 12). This pin 110 movably penetrates a cam hole 121 formed at an end of a link member 120 in the X direction. In the ejection direction of the end of this link member 120 in the −X direction (for example, refer to FIG. 11), an other end of a coil spring 131 whose one end is fixed to the chassis 20 is fixed, and the link member 120 is biased toward the −X direction. Further, at the end of the link member 120 in the −X direction, there is formed an elongate hole 133 through which a substantially cylindrical pin 132 formed in the chassis 20 penetrates, and which extends in the horizontal direction (−X and X directions). Furthermore, as explained in detail hereinafter, this link member 120 moves to the X direction (for example, refer to FIG. 27) against a biasing force of the coil spring 131 when the first disk guide 41 rotates so as to move the insertion roller 103 to the X direction from an initial state (for example, refer to FIG. 25), while the member moves to the −X direction (for example, refer to FIG. 37) when the guide rotates so as to move the insertion roller 103 to the −X direction.

Still further, in the −X direction of the end of the action lever 101 in the insertion direction, a protruding portion 123 (for example, refer to FIG. 12) protruding to the −X direction is formed, and a one end of a switch lever 124 is fitted to this protruding portion 123. This switch lever 124 is substantially L-shaped seen from a plane particularly as shown in FIG. 12, and a hole 125 is formed on a bent portion thereof, so that a substantially cylindrical pin 126 fixed to the chassis 20 is inserted in the hole 125 and thereby the switch lever is rotatably attached to the chassis 20 with this pin 126 being as the fulcrum. An other end of the switch lever 124 contacts a lever 57A of a disk discriminating switch 57 disposed on a back surface of the circuit board 50 explained in detail hereinafter (for example, refer to FIGS. 12 and 23) to then make the disk discriminating switch 57 in an ON state when the first disk guide 41 is in the initial state and as explained hereinafter, when the optical disk D8 of diameter 8 centimeters is inserted, while the other end of the switch lever 124 makes the disk discriminating switch 57 in an OFF state when the first disk guide 41 rotates so as to move the insertion roller 103 to the X direction (for example, refer to FIG. 25). It is to be noted that a size of the inserted optical disk is discriminated by an operation of this disk discriminating switch 57.

At the end of the bottom surface of the insertion arm 102 in the insertion direction, the substantially cylindrical pin 106 (for example, refer to FIG. 4) is set up toward the −Z direction. This pin 106 is movably inserted into the elongate hole 105 formed on the insertion arm 102 and the hole 19 formed in the bottom case 12. Substantially in a center of the insertion arm 102, there is formed a hole 108 through which a pin 109 attached to a supporting portion 22 (for example, refer to FIG. 3) protruding from the X direction of the chassis 20 penetrates, and the insertion arm 102 is rotatable with the pin 109 penetrating the hole 108 (refer to FIG. 2) being as the fulcrum.

The insertion roller 103 is rotatably attached to the insertion arm 102, and it is restrained from moving to the Z direction by a guide rail 23 disposed at the end of the chassis 20 in the ejection direction and also the X direction when the insertion arm 102 rotates, thus resulting in moving to the horizontal direction (−X and X directions). This insertion roller 103 is located in a predetermined −X direction of the guide rail 23 in the initial state (for example, refer to FIG. 5), but when the optical disk D12 of diameter 12 centimeters is inserted to some extent, the first position of the optical disk D12 contacts the insertion roller 103, and the optical disk D12 presses the roller to move it to the X direction of the guide rail 23. (For example, refer to FIG. 25).

The second disk guide 42 guides the optical disk D12 (D8) to the centering position while supporting a second position spaced apart from the first position of the peripheral of the optical disk D12 (D8). This second disk guide 42 is connected with a guide lever 201 located in the insertion direction at the ejection direction side of the guide lever 201, and it has a support lever 202 for supporting the information recording surface of the optical disk D12 (D8) when it is inserted and a link lever 203 whose one end is rotatably attached to the insertion direction of the guide lever 201 with the pin 212.

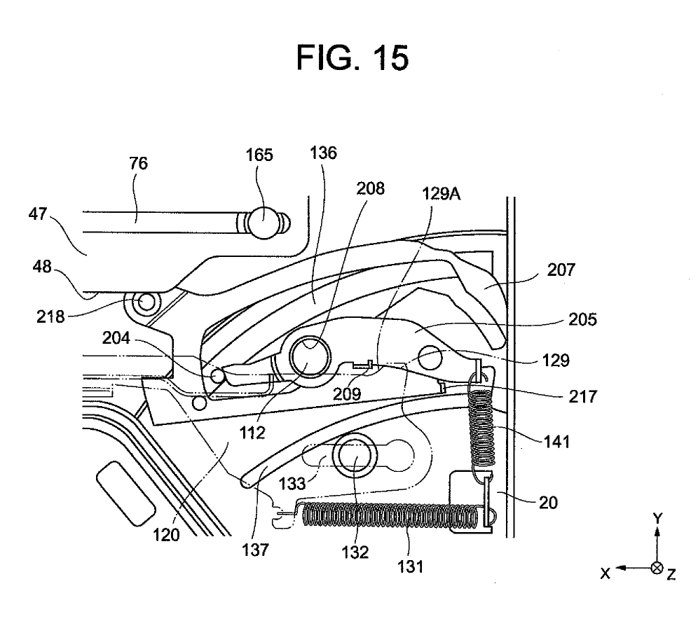

At an end of a bottom surface of the guide lever 201 in the insertion direction, a substantially cylindrical pin 204 (for example, refer to FIG. 15) is set up toward the −Z direction. This pin 204 movably penetrates a circular hole 136 formed in the chassis 20, and moves through the hole 136 to thereby move the guide lever 201 substantially in parallel in the horizontal direction (−X and X directions).

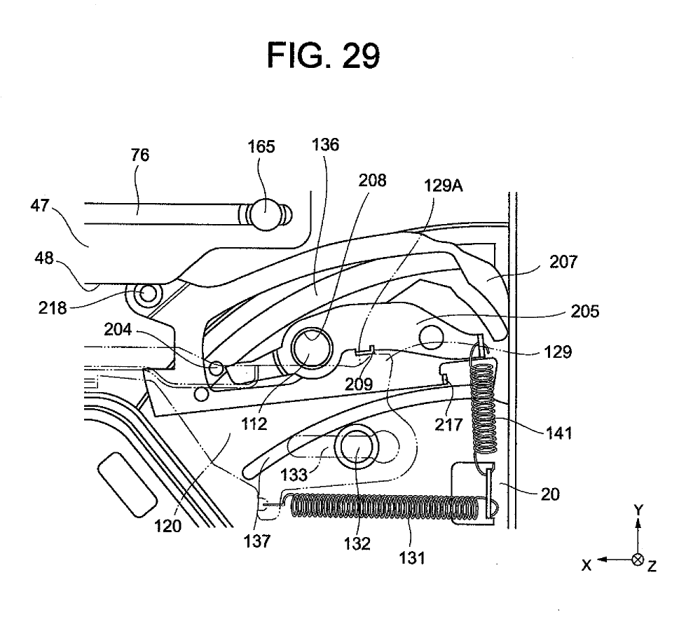

Here, with a common pin 112, to the chassis 20 are rotatably attached a locking lever 205 (for example, refer to FIG. 15) for contacting the pin 204 to be locked so that the guide lever 201 may not move to the −X direction and a locking control member 207 (for example, refer to FIG. 15) for preventing the locking lever 205 from returning to a locked position when it is unlocked. At a tip of the locking lever 205 in the −X direction (for example, refer to FIG. 15), an other end of a coil spring 141 whose one end is fixed to the chassis 20 is fixed. Additionally, in a position a little nearer the X direction than a center of the locking lever 205 (for example, refer to FIG. 15), there is formed a hole 208 through which the pin 112 disposed in the chassis 20 penetrates, and the locking lever 205 is rotatable with the pin 112 penetrating the hole 208 being as the fulcrum. Further, near the −X direction of the hole 208 formed on the locking lever 205 in the ejection direction (for example, refer to FIG. 15), a contact portion 209 with the link member 120 is provided. This contact portion 209 slidingly contacts a tapered surface 129A of an extending portion 129 extending to the insertion direction of the end of the link member 120 in the −X direction, when the link member 120 moves to the X direction (for example, refer to FIG. 29). By the above-described operation, the locking lever 205 rotates, for example, counterclockwise as shown in FIG. 29 against a biasing force of the coil spring 141 with the pin 112 penetrating the hole 208 being as the fulcrum, and thereby contact of the tip of the locking lever 205 in the X direction with the pin 204 is released (unlocked), thus enabling the guide lever 201 to move in parallel in the −X direction.

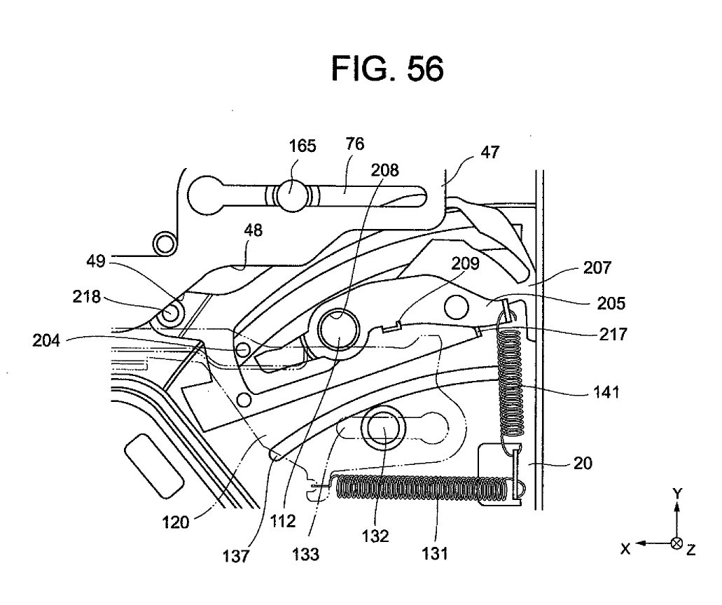

There is formed a convex portion 218 protruding to the −Z direction at a tip of the locking control member 207 in the X direction, and this convex portion 218, for example, as shown in FIG. 15, contacts an edge 48 of the cam member 47 in the −X direction and also the −Y direction when the locking control member 207 is located in an initial position, thereby preventing the locking control member 207 from rotating clockwise as shown in FIG. 15. Still further, a force for returning to the locked position acts on the locking lever 205 with the biasing force of the coil spring 141 even if it is unlocked, but when unlocked in a case of the optical disk D12 of diameter 12 centimeters being inserted, for example, as shown in FIG. 29, the contact portion 209 contacts to the extending portion 129, thereby preventing the locking lever 205 from returning to the locked position. Yet still further, when unlocked in a case of the optical disk D8 of diameter 8 centimeters being inserted, for example, as shown in FIG. 56, by movement of the cam member 47 to the −X direction, the convex portion 218 contacts an inclined surface 49 continuing to the edge 48 of the cam member 47 in the X direction, and the locking control member 207 rotates counterclockwise as shown in FIG. 56 from a position shown in FIG. 29 and thereby a locking portion 217 formed on the locking control member 207 contacts the locking lever 205, so that the locking lever 205 is prevented from returning to a position where the pin 204 is locked and thereby the guide lever 201 can move to the −X direction.

A little nearer the ejection direction than a position where the pin 204 of the guide lever 201 is formed, the link lever 203 is rotatably disposed by a substantially cylindrical pin 212. An end of the link lever 203 in the ejection direction is rotatably attached to the chassis 20 with a pin 210, and the link lever 203 rotates with the end thereof in the ejection direction being as the fulcrum to thereby move the guide lever 201 substantially in parallel in the horizontal direction. Additionally, on a bottom surface in a substantially central portion of the link lever 203, a spring fixing portion 213 is formed protruding to the −Z direction, which movably penetrates a circular hole 138 formed in the chassis 20 and to which a one end of a torsion coil spring 214 (for example, refer to FIG. 11) is fixed. An other end and a central portion of the torsion coil spring 214 are fixed to the chassis 20, for example, as shown in FIG. 11, and thereby the spring biases the link lever 203 toward an initial position (X direction shown in FIG. 11).

To an end of the guide lever 201 in the ejection direction, a one end of the substantially fan-shaped support lever 202 seen from a plane is rotatably attached with a pin 206 being as the fulcrum. Meanwhile, an other end of the support lever 202 (end in the ejection direction) is rotatably attached to the chassis 20.

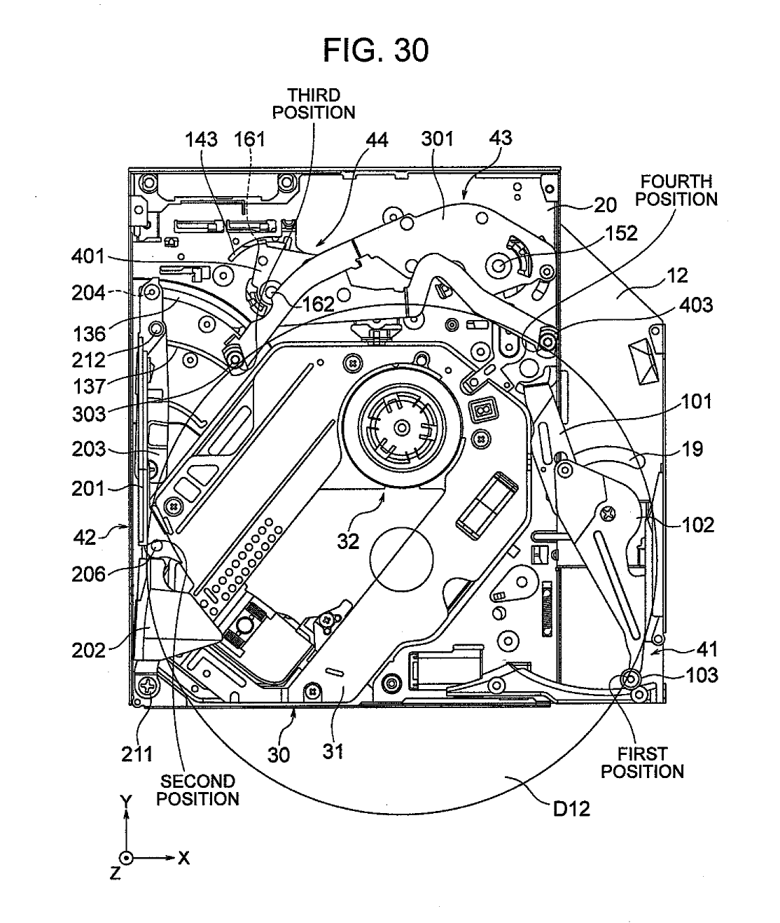

The third disk guide 43 supports a third position nearer the insertion direction than the first position of the optical disk D12 (D8) guided by the first disk guide 41 and the second disk guide 42 (for example, refer to FIG. 30), and then guides the optical disk D12 (D8) to the centering position along with the first disk guide 41 and the second disk guide 42. This third disk guide 43 is rotatably attached to a tip of an eject arm 301 located in the insertion direction in the ejection direction, and has an eject roller 303 for supporting the third position of the peripheral end surface of the optical disk D12 (D8).

On a bottom surface of an end of the eject arm 301 in the insertion direction, a substantially cylindrical pin 221 (for example, refer to FIG. 3) is set up toward the −Z direction, and this pin 221 movably penetrates a circular hole 151 formed in the insertion direction (opposed to the ejection direction) and also the X direction of the chassis 20. A little nearer the ejection direction than a position where the pin 221 of the eject arm 301 is formed, a hole 153 through which a pin 152 attached to the chassis 20 penetrates is formed, and the eject arm 301 is rotatable with the pin 152 penetrating the hole 153 being as the fulcrum. The pin 221 engages with a hole, not shown, that is provided on an ejector 150 explained in detail hereinafter, and it rotates so that the eject arm 301 may return to an initial direction with the pin 152 inserted into the hole 153 being as the fulcrum when the eject button 14 is pushed and thereby pushes the optical disk D12 (D8) to the ejection direction to be ejected.

Additionally, at the bottom surface of the end near the hole 153 of the eject arm 301 in the insertion direction, a substantially cylindrical pin 222 (for example, refer to FIGS. 5 and 12) is set up toward the −Z direction, and this pin 222 movably penetrates a circular hole 155 (refer to FIG. 2) formed in the insertion direction and also the X direction of the chassis 20. A one end of a torsion coil spring 215 is fixed to this pin 222 (for example, refer to FIG. 12), while an other end and a central portion of the torsion coil spring 215 are fixed to the chassis 20, and thereby the eject arm 301 is biased toward an initial direction (counterclockwise shown in FIG. 5).

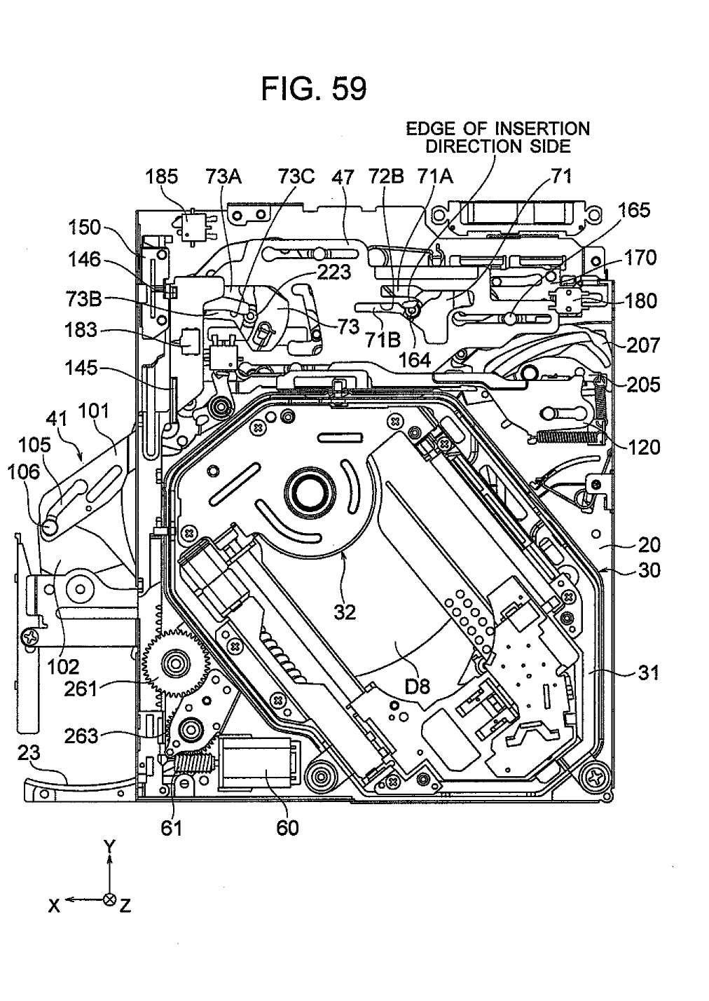

Further, on a bottom surface of a position having the pin 222 formed of the eject arm 301 in the −X direction, a substantially cylindrical pin 223 (for example, refer to FIGS. 5 and 11) is set up toward the −Z direction, and this pin 223 movably penetrates a hole 155 (refer to FIG. 2) along with the above-mentioned pin 222. Furthermore, this pin 223 is movably inserted into a cam hole 73, explained in detail hereinafter, formed on the cam member 47, and it contacts an edge 73C of a cam hole 73B for the optical disk of diameter 8 centimeters of the cam hole 73 in the insertion direction (for example, refer to FIG. 59) when the cam member 47 moves to the −X direction and, for example, the optical disk D8 of diameter 8 centimeters is centered.

The fourth disk guide 44 supports a fourth position nearer the insertion direction than the second position of the optical disk D12 (D8) guided by the first disk guide 41 and the second disk guide 42, the position also being spaced apart from the third position (for example, refer to FIG. 30), and then guides the optical disk D12 (D8) to the centering position along with the first disk guide 41 and the second disk guide 42. This fourth disk guide 44 is rotatably attached to a tip of a disk arm 401 located in the insertion direction in the ejection direction and has a disk roller 403 for supporting the fourth position of the peripheral end surface of the optical disk D12 (D8). Incidentally, each of “nearer the insertion direction” and “inserting or insertion direction side” means “arranged (relatively) farther in the inserting or insertion direction”, that is, “arranged in a range shown by an arrow mark A or B in FIG. 25”. Further, the third or fourth position moves from the center of the optical disk toward the centering guiding position in accordance of a proceeding of the insertion of the optical disk. The guide engages or contacts with the edge of the insertion direction side of the hole.

On a bottom surface of an end of the disk arm 401 in the insertion direction and also the X direction, a protruding portion 161 extending toward the −Z direction (for example, refer to FIG. 5) is formed. This protruding portion 161 engages with a substantially fan-shaped cam hole 171 seen from a plane that is formed on a switch plate 170, explained in detail hereinafter, disposed on a back surface of the chassis 20 (for example, refer to FIG. 11), as well as the portion movably penetrates a circular hole 143 formed in the chassis 20. The switch plate 170 switches a loading switch 180 from an OFF state to an ON state or from the ON state to the OFF state for switching on a loading motor 60, which is a component of a drive unit 46 described hereinafter. It is to be noted that the loading switch 180 is disposed on the circuit board 50, and it is an ON-OFF state when the switch plate 170 is in an initial position.

Additionally, substantially in a center of the switch plate 170, an elongate hole 173 extending to the horizontal direction (−X and X directions) is formed, and a boss portion 175 formed in the chassis 20 is inserted into this elongate hole 173. Further, an end of the switch plate 170 in the insertion direction is attached to guide portions 176 and 177 formed in the chassis 20 movably in the horizontal direction (−X and X directions). Furthermore, in the −X direction of the switch plate 170 shown in FIG. 11, there are disposed switching convex portions 178A and 178B on both sides of a switch lever 181, which contact the switch lever 181 of the loading switch 180 to then switch the switch lever 181 when the switch plate 170 moves to the horizontal direction (−X and X directions). This switch plate 170 moves to the −X direction (for example, refer to FIG. 11) when the fourth disk guide 44 rotates in a loading direction of the optical disk (for example, counterclockwise shown in FIG. 5) against a biasing force of a torsion coil spring 216 explained in detail hereinafter. It is to be noted that the protruding portion 161 is engaged to a tip of the cam hole 171 in the insertion direction when being in an initial state.

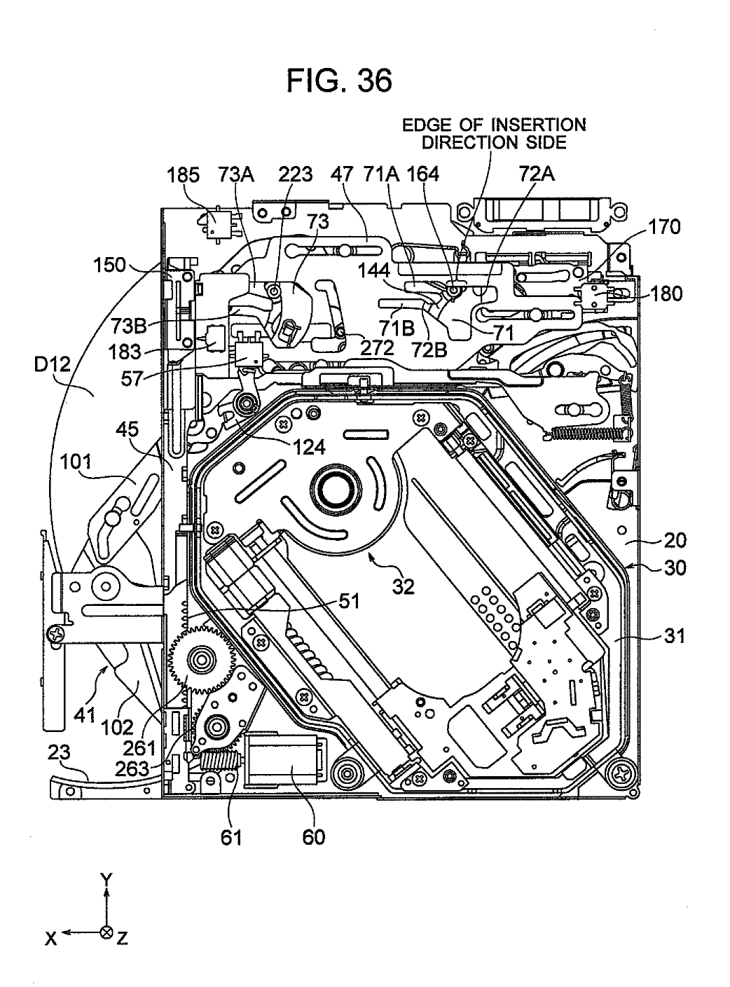

Additionally, substantially in a center of the disk arm 401 in the insertion direction, there is formed a hole 163 through which a pin 162 attached to the chassis 20 penetrates, and the disk arm 401 is rotatable with this pin 162 being as the fulcrum. Furthermore, on a bottom surface a little nearer the ejection direction and also the X direction than a position where the hole 163 of the disk arm 401 is formed, a substantially cylindrical pin 164 is set up toward the −Z direction (for example, refer to FIGS. 5 and 11). This pin 164 movably penetrates a circular hole 144 formed in the chassis 20, and thereby a one end of the torsion coil spring 216 is fixed (for example, refer to FIG. 11). An other end and a central portion of the torsion coil spring 216 are fixed to the chassis 20, and thereby the disk arm 401 is biased toward an initial direction (clockwise shown in FIG. 5). Moreover, the pin 164 is movably inserted into a cam hole 71, explained in detail hereinafter, formed on the cam member 47, and it contacts an edge 72A of the cam hole 71 in the insertion direction (for example, refer to FIG. 36) when the cam member 47 moves to the −X direction (for example, refer to FIG. 36) and, for example, the optical disk D12 of diameter 12 centimeters is guided to the centering position.

The function lever 45 is attached to a bottom surface of the chassis 20 in the X direction movably along from the insertion direction to the ejection direction, and for example, as shown in FIG. 10, a cam groove 501 for the optical disk of diameter 12 centimeters and a cam groove 502 for 8 centimeters are formed in order from the X direction in a top surface of the end in the insertion direction. These cam grooves 501 and 502 serve as a merging portion 503 in the ejection direction. Additionally, at a tip of the function lever 45 nearer the insertion direction than the cam grooves 501 and 502, there is formed an engaging groove 504 to which a pin 271 engages that is set up toward the −Z direction from a bottom surface of a side end of the control arm 270 explained in detail hereinafter (for example, refer to FIG. 7) in the insertion direction.

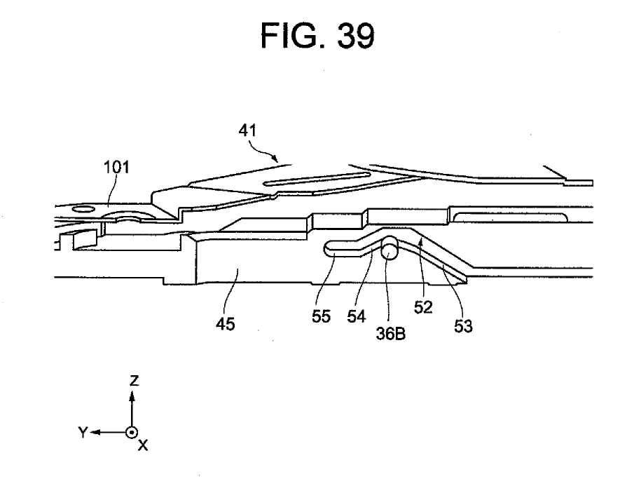

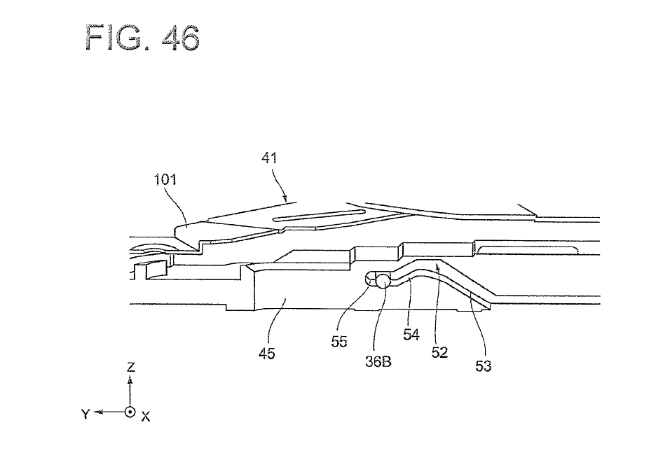

On a side surface in the −X direction of the end of the function lever 45 in the ejection direction, there is formed a rack 51 (for example, refer to FIG. 21) for engaging with a gear 261, which is a configuration requirement of the drive unit 46 explained in detail hereinafter. Further, substantially in a center of the side surface of the function lever 45 in the −X direction, the inclined hole 52 is formed. A bottom surface for demarcating this inclined hole 52 is formed of an inclined surface 53 located in the ejection direction and descending toward the ejection direction, an inclined surface 54 located in the insertion direction of the inclined surface 53 and descending toward the insertion direction, and a horizontal surface 55 located in the insertion direction of the inclined surface 54. It is to be noted that as explained in detail hereinafter, when the pin 36B formed in a side surface of the mechanical deck member 31 in the X direction (for example, refer to FIGS. 39 and 46) is inserted into this inclined hole 52 to then move, according to this movement, the optical disk D12 (D8) is put into a chucking state or a state of recording/reproducing (playing) information.

Furthermore, in the −X direction of an end of a bottom surface of the function lever 45 in the insertion direction (for example, −X direction shown in FIG. 11), there is formed a switching convex portion 145 for contacting a switch lever 184 of a mode switch 183 (for example, refer to FIG. 11) disposed on the circuit board 50 to then switch the switch lever 184. It is to be noted that the mode switch 183 is a switch for detecting that the function lever 45 has moved to a position where the optical disk can be played (position where it can be recorded or reproduced) in the apparatus, and since the apparatus employs the switch having two contact structures, two mechanical modes are detectable with one mode switch 183. Namely, when the function lever 45 is in an initial position, the switch lever 184 is laid down to the insertion direction to thereby be in an initial ON state, which indicates that the function lever 45 has not moved to a play position, while when the switch lever 184 is in a neutral position, the apparatus is in an OFF state. When the function lever 45 moves to the play position, the switch lever 184 is laid down to the ejection direction from the neutral position to thereby be in a play ON state.

Additionally, in the −X direction of the end nearer the insertion direction than the switching convex portion 145 of the bottom surface of the function lever 45 (for example, −X direction shown in FIG. 11), there is formed a switching convex portion 146 for contacting a switch lever 186 of an eject switch 185 (for example, refer to FIG. 11) disposed on the circuit board 50 to then switch the switch lever 186. It is to be noted that the eject switch 185 is a switch for detecting that the function lever 45 has moved to an eject position, when the function lever 45 is in the initial position, the apparatus is in the OFF state. Further, at a tip of the function lever 45 of the chassis 20 in the insertion direction, the ejector 150 is disposed.

The drive unit 46 is fixed to the ejection direction and also the X direction of the chassis 20, and provides the loading motor 60 for generating a driving force for performing a loading operation and an eject operation of the optical disk D12 (D8), a rotational operation of the traverse unit 30, etc, a worm gear 61 formed on an axis of rotation of the loading motor 60, a gear 263 for engaging to the worm gear 61, a gear 262 for engaging with the gear 263, and a gear 261 for engaging with the gear 262 and the rack 51, and these gear trains constitute a driving force transmission system of the loading motor 60.

The control arm 270 is substantially L-shaped seen from a plane, and drives the cam member 47 explained in detail hereinafter. On a bottom surface of a side end of the control arm 270 in the insertion direction, the substantially cylindrical pin 271 (for example, refer to FIG. 7) is set up toward the −Z direction. This pin 271 is inserted into the engaging groove 504 of the function lever 45 to thereby engage to the engaging groove 504. On a bottom surface of an end of the control arm 270 in the ejection direction (for example, refer to FIG. 7), a substantially cylindrical pin 272 is set up toward the −Z direction. This pin 272 movably penetrates a cam hole 75 (for example, refer to FIGS. 7 and 8) formed on the cam member 47 explained in detail hereinafter. Additionally, substantially in a center of the control arm 270, for example, as shown in FIG. 9, there is formed a hole 276 through which a pin 275 set up toward the −Z direction from the bottom surface of the chassis 20 penetrates, and the control arm 270 is rotatable with this pin 275 being as the fulcrum. The function lever 45 moves to the ejection direction, and thereby, for example, this control arm 270 rotates counterclockwise as shown in FIG. 37 from a position in FIG. 9 with the pin 275 being the fulcrum as shown in FIG. 37 to thereby move the cam member 47 to a position shown in FIG. 36 (namely, −X direction) from a position shown in FIG. 8.

The cam member 47 is disposed on the chassis 20 in the insertion direction movably in the horizontal direction (−X and X directions). On a surface opposed to a top surface of the chassis 20 of this cam member 47, particularly as shown in FIG. 18, in order from the −X direction, there are formed an elongate hole 76 into which a substantially cylindrical pin 165 formed on the top surface of the chassis 20 is inserted relatively movably in the horizontal direction (−X and X directions), the cam hole 71 into which the pin 164 formed on the disk arm 401 is relatively movably inserted, an elongate hole 77 into which a substantially cylindrical pin 166 (for example, refer to FIG. 8) formed on the top surface of the chassis 20 is inserted relatively movably in the horizontal direction (−X and X directions), the cam hole 75 into which the pin 272 (for example, refer to FIG. 8) formed on the control arm 270 is relatively movably inserted, and the cam hole 73 into which the pin 223 formed on the eject arm 301 is relatively movably inserted. Additionally, in the ejection direction of the cam hole 75 and the cam hole 73 of the cam member 47, there is formed an elongate hole 78 into which a substantially cylindrical pin 167 formed on the top surface of the chassis 20 is inserted relatively movably in the horizontal direction (−X and X directions).

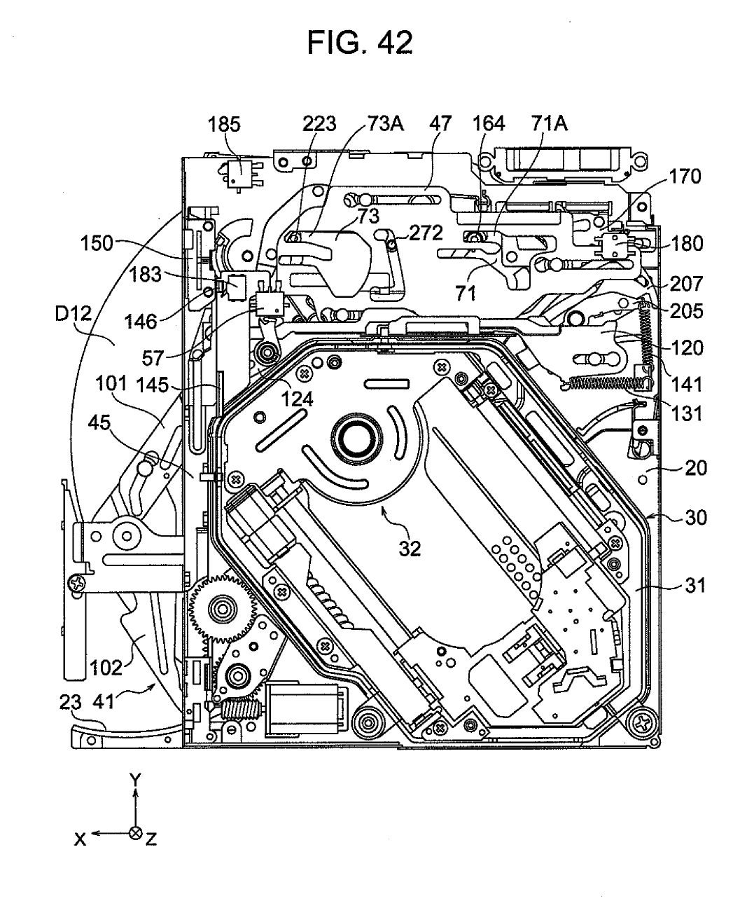

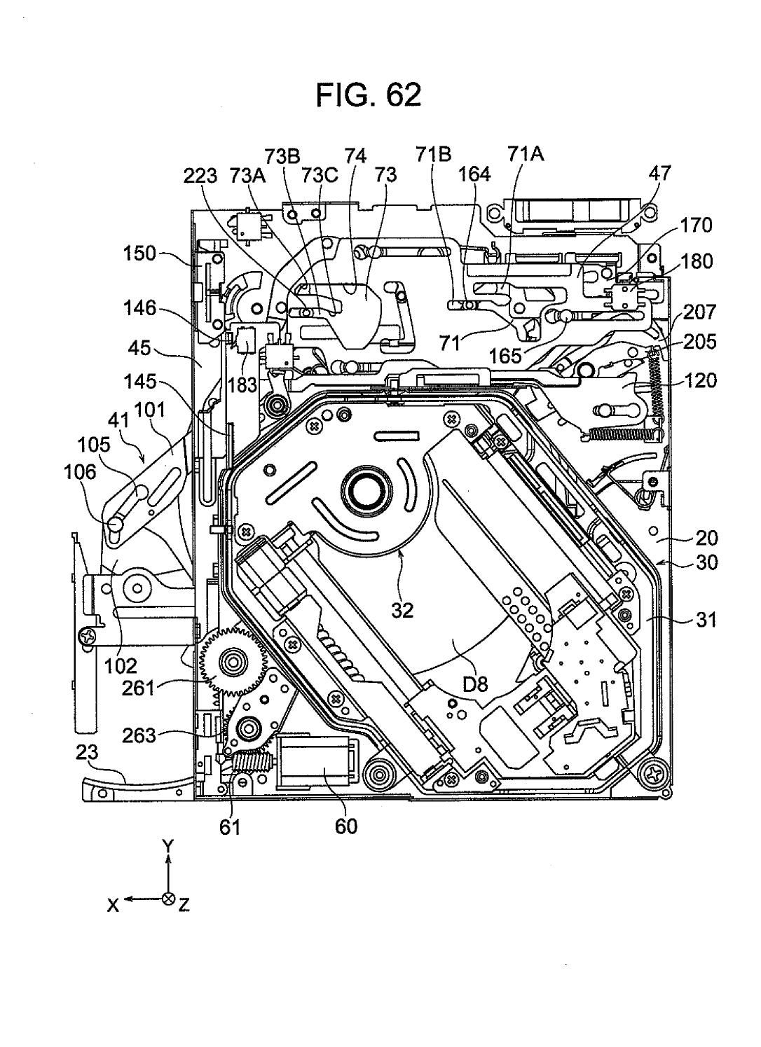

The X direction of the cam hole 71 is branched into two particularly as shown in FIG. 18, and the pin 164 is located in a branch hole 71A located in the insertion direction when the optical disk D12 of diameter 12 centimeters is in a play state (for example, refer to FIG. 42), while the pin 164 is located in a branch hole 71B located in the ejection direction when the optical disk D8 of diameter 8 centimeters is in a play state (for example, refer to FIG. 62).

The X direction of the cam hole 73 is branched into two particularly as shown in FIG. 18, the pin 223 is located in a branch hole 73A located in the insertion direction when the optical disk D12 of diameter 12 centimeters is in the play state (for example, refer to FIG. 42), while the pin 223 is located in a branch hole 73B located in the ejection direction when the optical disk D8 of diameter 8 centimeters is in the play state (for example, refer to FIG. 62).

The cam hole 75 is substantially L-shaped extending from the ejection direction to the insertion direction, and the pin 272 is located in the ejection direction in an initial state (for example, refer to FIG. 8), while the pin 272 is located in the insertion direction when the optical disk D12 (D8) is in the play state (For example, refer to FIG. 42.).

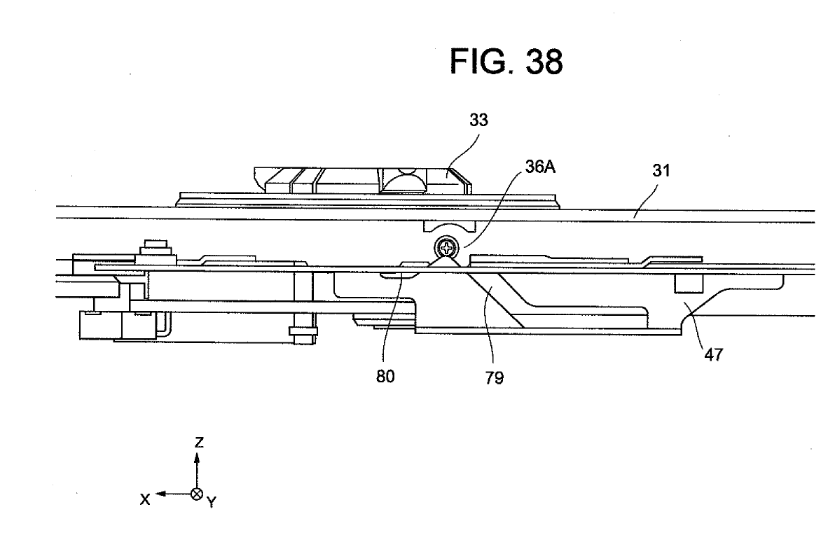

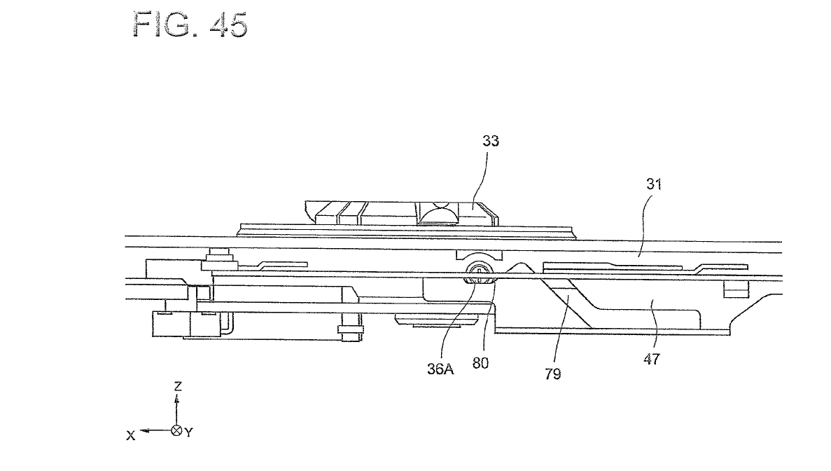

On the end surface of the cam member 47 in the ejection direction, particularly as shown in FIG. 18, there are formed the inclined hole 79 inclining in the Z direction from the −X direction toward the X direction, and the horizontal hole 80 continuously formed in the X direction of the inclined hole 79. The pin 36A formed on the mechanical deck member 31 is inserted into the inclined hole 79 and the horizontal hole 80 relatively movably in the horizontal direction (−X and X directions). The pin 36A is located in the −Z direction and also the −X direction of the inclined hole 79 as shown in FIG. 16 in an initial state, while it is located in an uppermost portion of the inclined hole 79 as shown in FIG. 38 when chucking the optical disk D12 (D8), and the mechanical deck member 31 has moved to the Z direction. Additionally, the pin 36A is located in the horizontal hole 80 as shown in FIG. 45 in the play state.

Next, specific operations of the optical disk apparatus 1 according to the present embodiment will be explained with reference to the drawings.

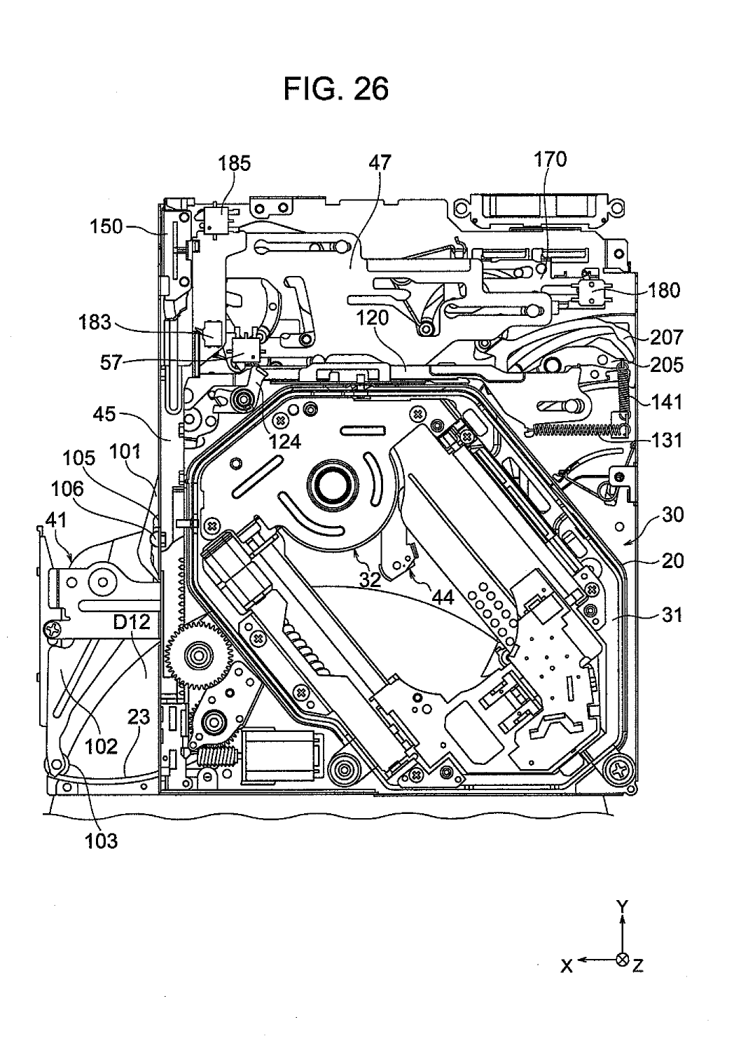

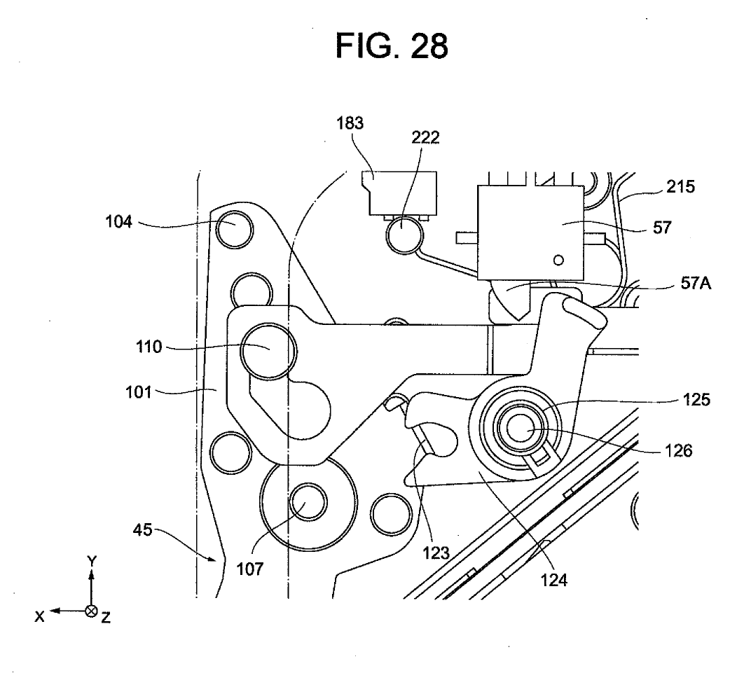

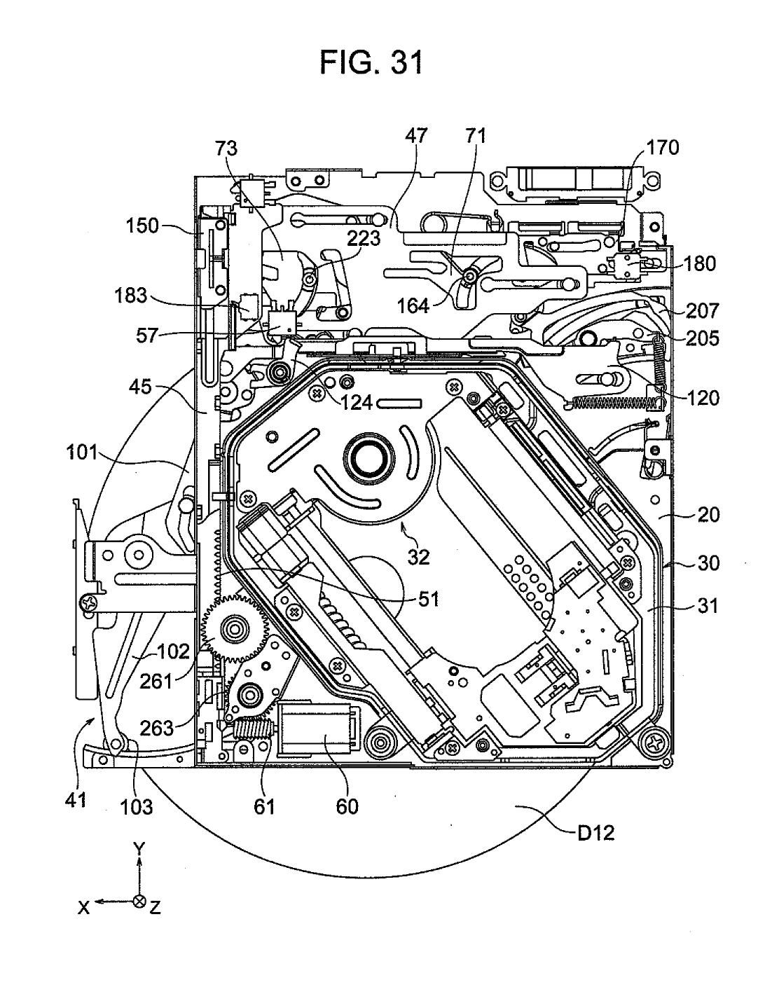

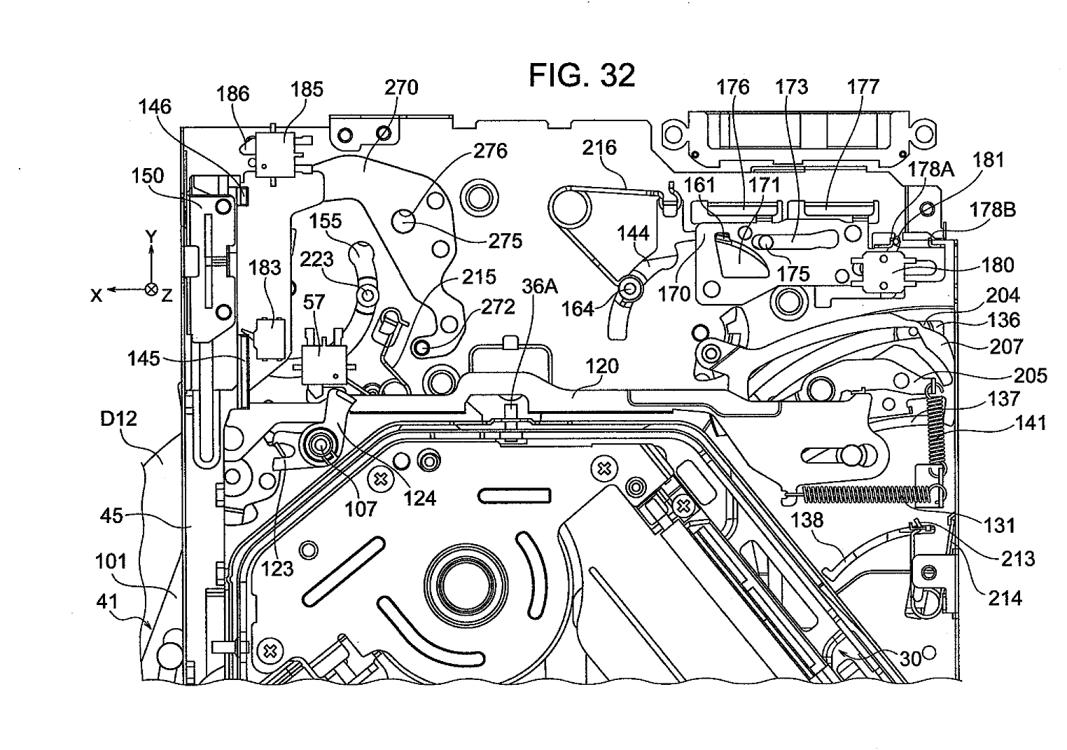

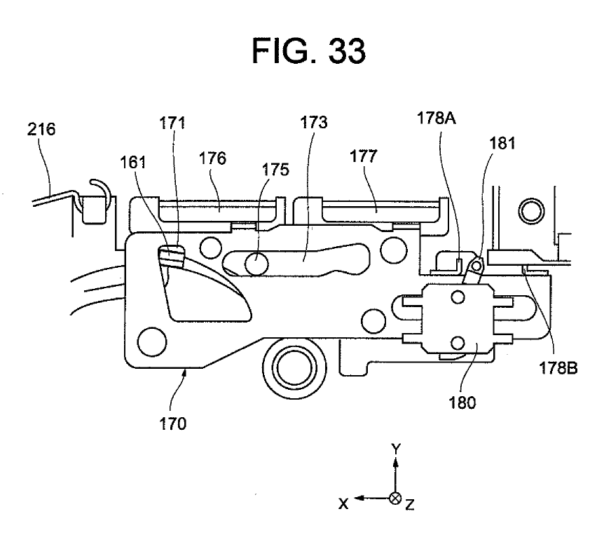

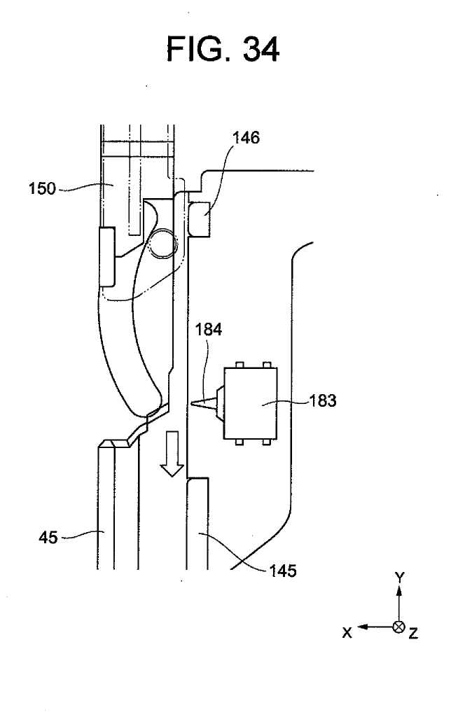

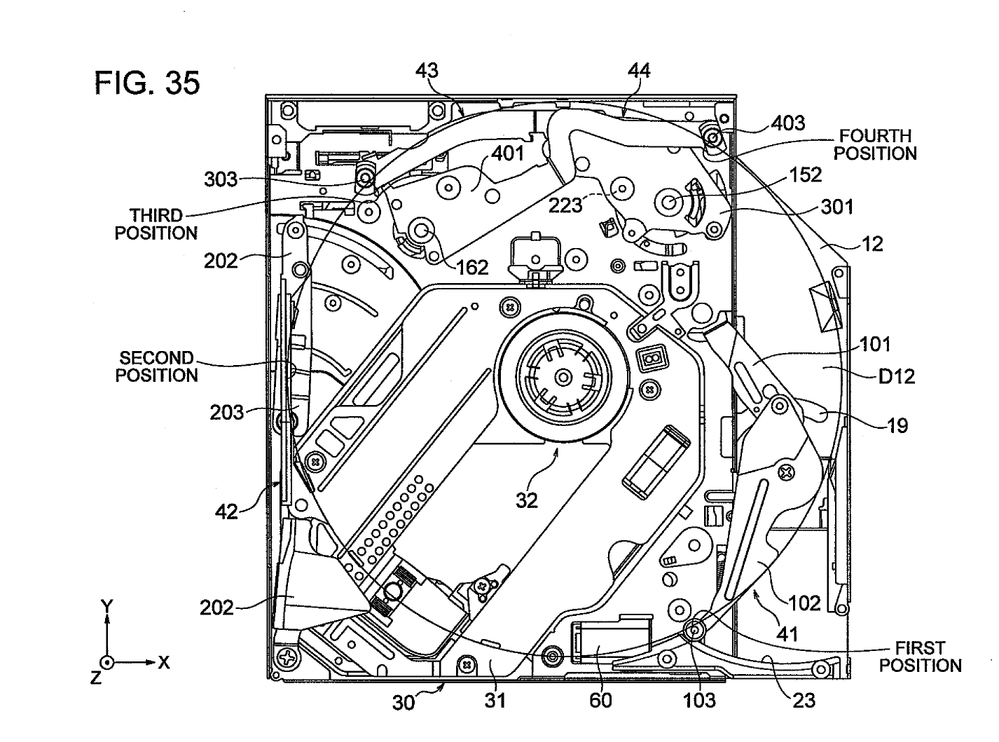

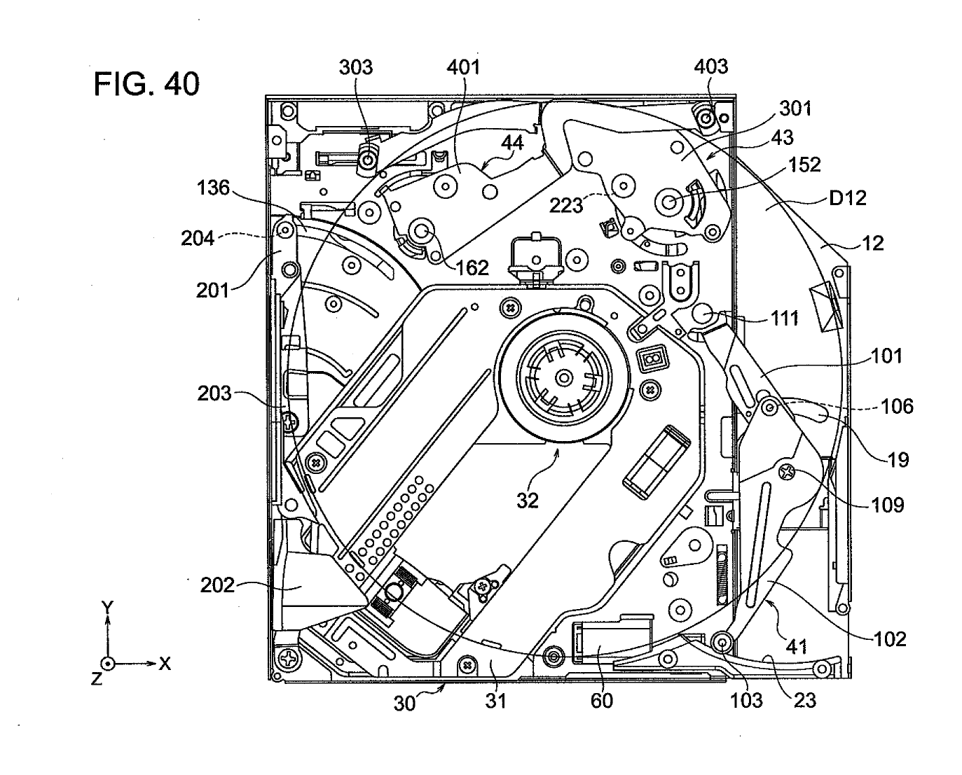

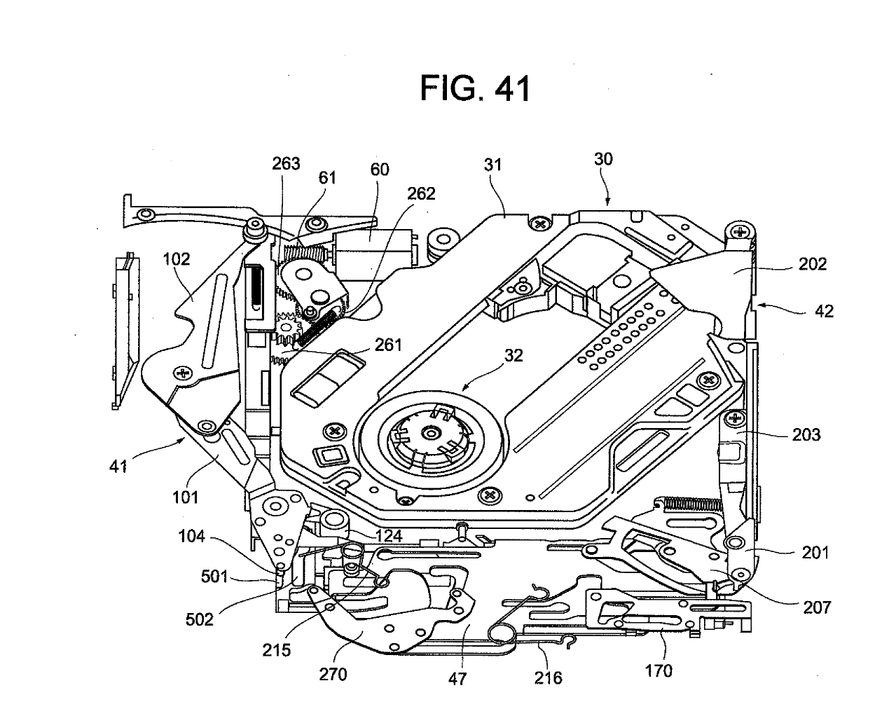

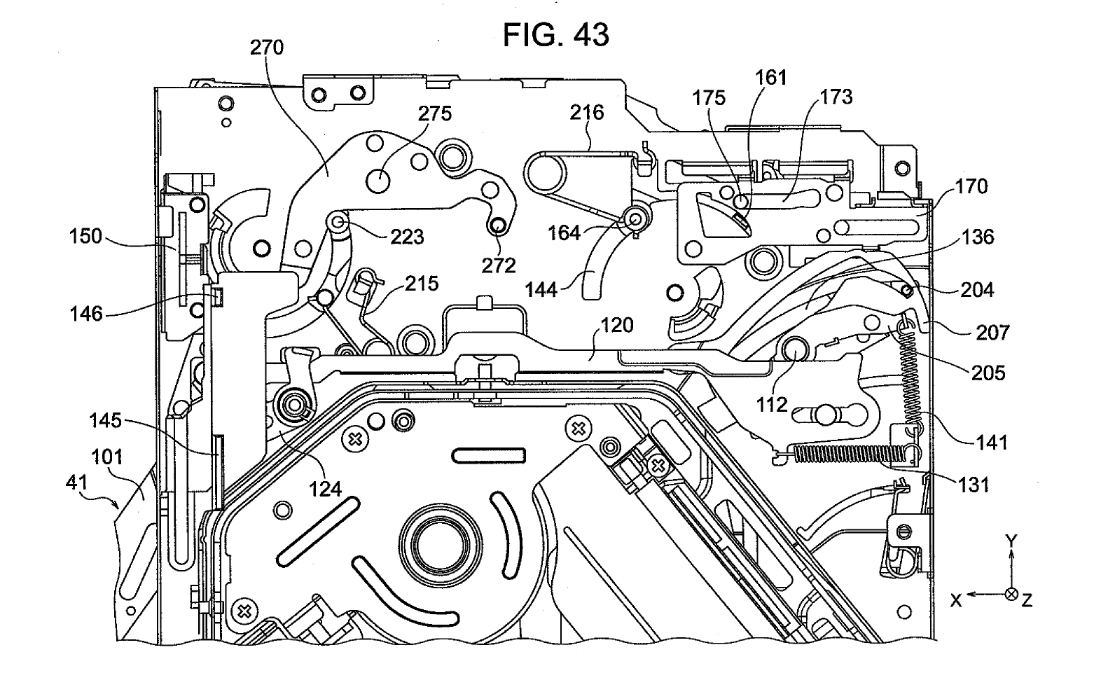

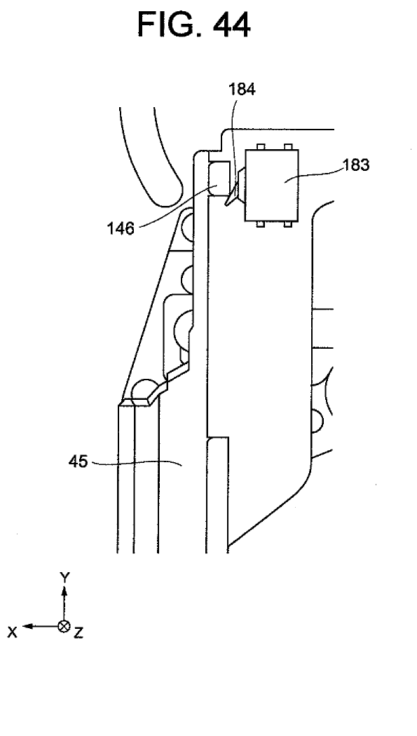

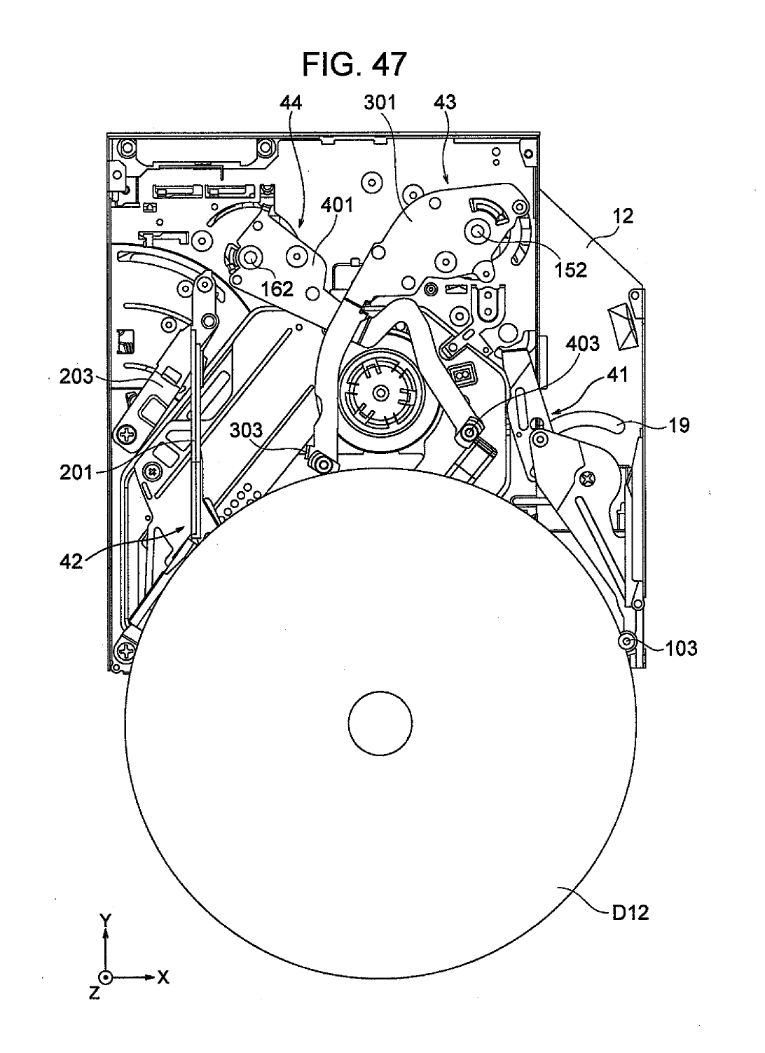

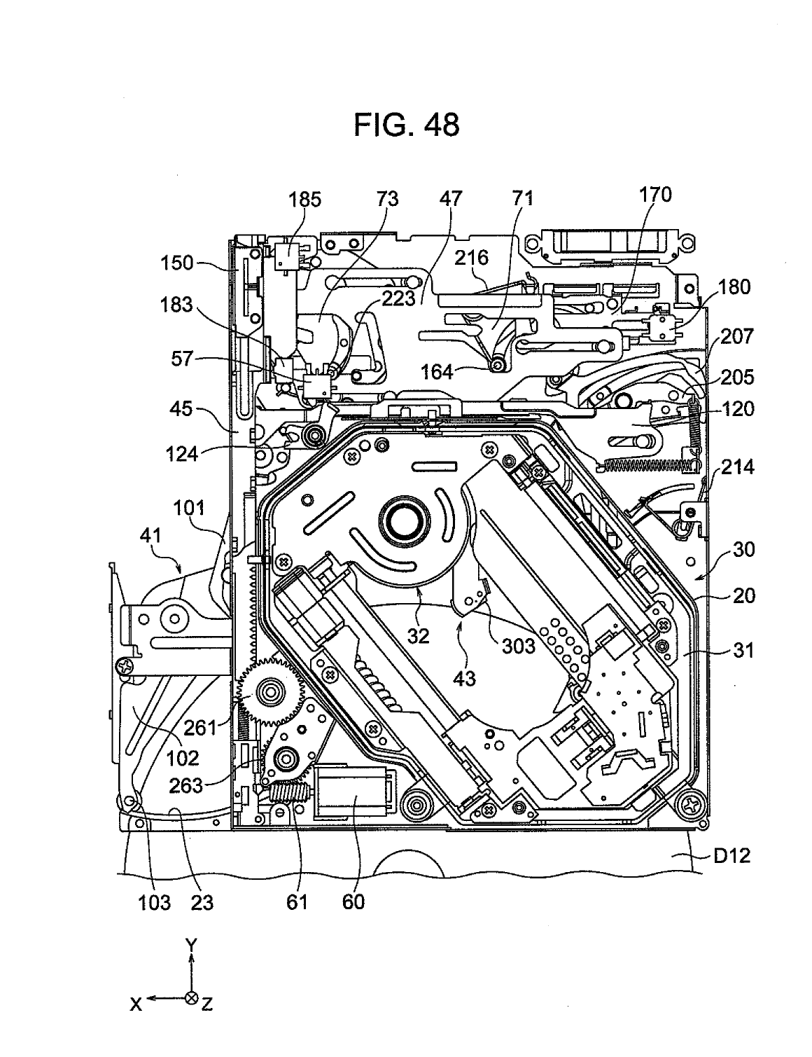

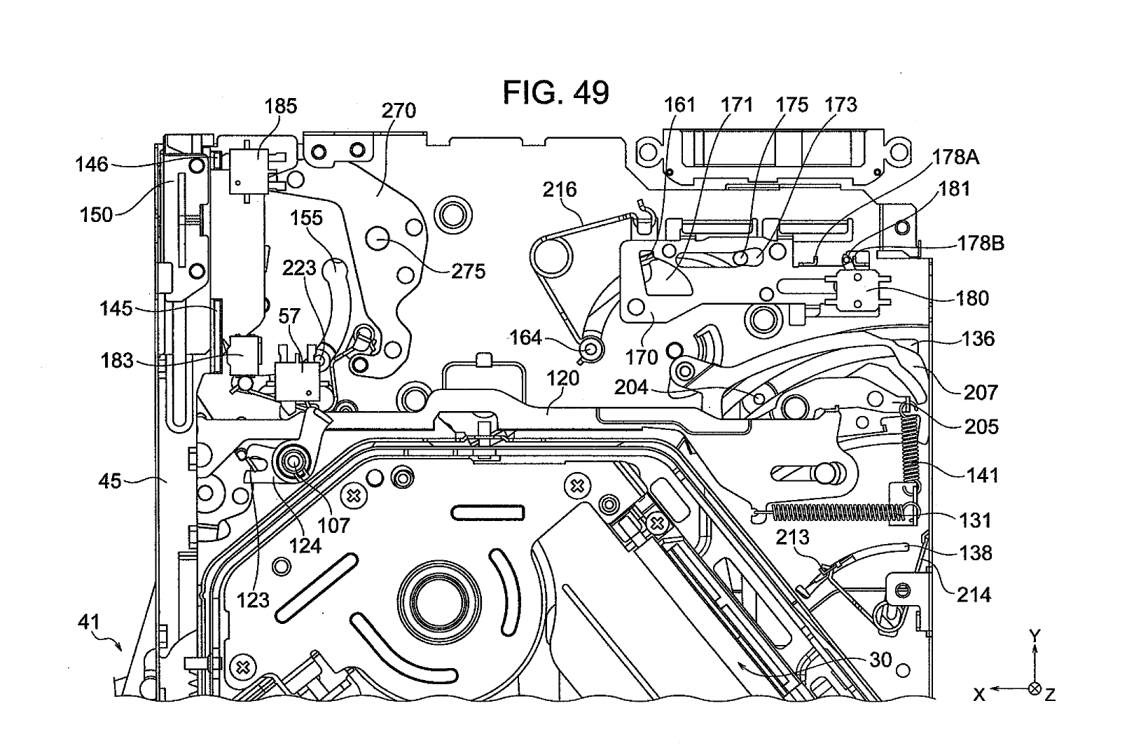

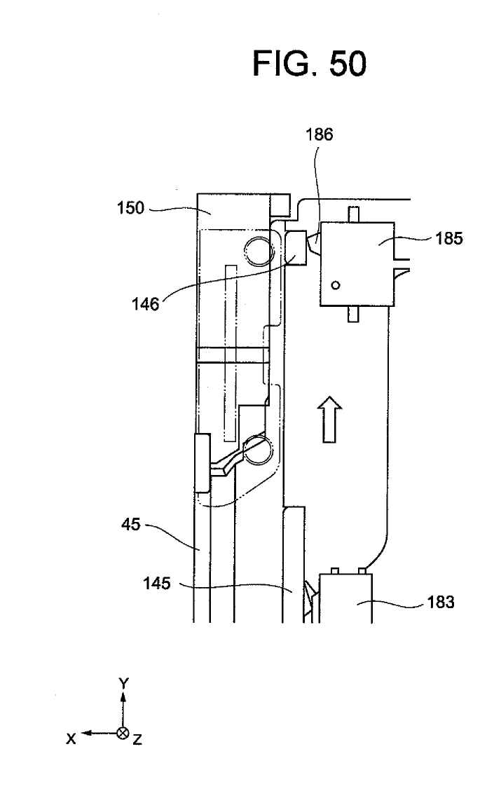

FIG. 25 is a plane view seen from the top without a top cover showing a state where the optical disk of diameter 12 centimeters is being inserted into the optical disk apparatus according to the present embodiment; FIG. 26 is a bottom view showing a state where a bottom case and the circuit board are eliminated from the state shown in FIG. 25; FIG. 27 is a partial enlarged bottom view showing a state where the cam member is eliminated from the state shown in FIG. 26; FIG. 28 is a further enlarged partial bottom view of the state shown in FIG. 27; FIG. 29 is a further enlarged partial bottom view of the state shown in FIG. 26; FIG. 30 is a plane view showing a state where the optical disk is further inserted in the state shown in FIG. 25 to thereby start a loading motor; FIG. 31 is a bottom view showing a state where the bottom case and the circuit board are eliminated from the state shown in FIG. 30; FIG. 32 is a partial enlarged bottom view showing a state where the cam member is eliminated from the state shown in FIG. 31; FIGS. 33 and 34 are further enlarged partial bottom views of the state shown in FIG. 32; FIG. 35 is a plane view showing a state where the optical disk is further inserted in the state shown in FIG. 30 and then it is centered; FIG. 36 is a bottom view showing a state where the bottom case and the circuit board are eliminated from the state shown in FIG. 35; FIG. 37 is a partial enlarged bottom view showing a state where the cam member is eliminated from the state shown in FIG. 36; FIG. 38 is a partial view of the unit shown in FIG. 35 seen from the insertion direction; FIG. 39 is a partial view of the unit shown in FIG. 35 seen from the left side; FIG. 40 is a plane view seen from the top without the top cover showing a state where the optical disk of diameter 12 centimeters can be played; FIG. 41 is a partial exploded perspective view from the Y direction showing a state where the chassis, the third disk guide, and the fourth disk guide are eliminated from the unit shown in FIG. 40; FIG. 42 is a bottom view showing a state where the bottom case and the circuit board are eliminated from the state shown in FIG. 40; FIG. 43 is a partial enlarged bottom view showing a state where the cam member is eliminated from the state shown in FIG. 42; FIG. 44 is a partial enlarged bottom view of the unit shown in FIG. 42; FIG. 45 is a partial view of the unit shown in FIG. 40 seen from the insertion direction; FIG. 46 is a partial view of the unit shown in FIG. 40 seen from the left side; FIG. 47 is a plane view seen from the top without the top cover showing a state where the optical disk of diameter 12 centimeters is ejected; FIG. 48 is a bottom view showing a state where the bottom case and the circuit board are eliminated from the state shown in FIG. 47; FIG. 49 is a partial enlarged bottom view showing a state where the cam member is eliminated from the state shown in FIG. 48; and FIG. 50 is a further enlarged partial bottom view of the state shown in FIG. 49.

It is to be noted that thickness, size, enlargement/reduction rate, etc. of each member in the each drawing are illustrated differently from those of real things in order to clarify the explanation herein. Additionally, symbols are given to parts required for explanation and to main parts in FIGS. 25 to 50 in order to avoid complication, and parts without symbols correspond to equivalent parts illustrated in FIGS. 1 to 24.

First, when a user inserts the optical disk D12 of diameter 12 centimeters into the housing 10 of the optical disk apparatus 1 in an initial state (for example, refer to FIG. 5) from the opening 13A formed on the front panel 13, the peripheral surface of the optical disk D12 (first position) contacts the insertion roller 103 disposed at the tip of the first disk guide 41 in the ejection direction. At this time, since the locking lever 205 is in contact with the pin 204 formed on the guide lever 201 (for example, refer to FIG. 15), the second disk guide 42 is locked so as not to move to the −X direction.

When the optical disk D12 is further inserted into the housing 10, the first position of the optical disk D12 presses the insertion roller 103, and with this pressing force, the insertion arm 102 rotates counterclockwise as shown in FIG. 25 with the pin 109 being as the fulcrum. By this operation, the pin 106 disposed in the insertion direction of the insertion arm 102 moves counterclockwise as shown in FIG. 25 in the hole 19, and at the same time, it rotates the action lever 101 clockwise as shown in FIG. 25 (counterclockwise as shown in FIG. 26) with the pin 111 being as the fulcrum. By the above-described rotation, the action lever 101 rotates the switch lever 124 clockwise as shown in FIG. 26 from an initial position (for example, refer to FIGS. 11 and 12) with the pin 107 being as the fulcrum, and then makes the switch lever 124 break contact with the lever 57A of the disk discriminating switch 57 to thereby make the disk discriminating switch 57 into an OFF state (for example, refer to FIG. 28) from an ON state (for example, refer to FIG. 12). When the disk discriminating switch 57 is put into the OFF state as described above, the optical disk apparatus 1 recognizes that the optical disk D12 of diameter 12 centimeters has been inserted. The insertion roller 103 moves counterclockwise as shown in FIG. 25 along the guide rail 23 while being pressed by the optical disk D12.

Additionally, by the insertion of the optical disk D12, the peripheral end surface nearer the −X direction than the first position of the optical disk D12 (second position) contacts a vicinity of the tip of the guide lever 201 in the ejection direction, and at the same time, the information recording surface of the optical disk D12 is placed on the support lever 202 to thereby be supported as shown in FIG. 25. Further, by the above-described rotation, the action lever 101 moves the link member 120 to the X direction (for example, refer to FIG. 27) against the biasing force of the coil spring 131 from an initial position (for example, refer to FIG. 11). By this movement of the link member 120 to the X direction, the extending portion 129 formed on the link member 120 slidingly contacts the contact portion 209 formed on the locking lever 205 (for example, refer to FIG. 29), and the locking lever 205 rotates counterclockwise as shown in FIG. 29 against a biasing force of the coil spring 141 with the pin 112 being as the fulcrum, and thereby contact of the tip of the locking lever 201 in the X direction with the pin 204 is released (unlocked), thus enabling the guide lever 201 to move in parallel in the −X direction.

Next, when the optical disk D12 is further inserted into the housing 10 from the above-described state, the guide lever 201 is pressed by the optical disk D12, and the pin 204 moves to the −X direction in the hole 136, and thereby the guide lever 201 moves to the −X direction. When the pin 212 moves to the −X direction along with this movement of the guide lever 201, the connected link lever 203 rotates counterclockwise as shown in FIG. 30 against a biasing force of the torsion coil spring 214 with the pin 210 being as the fulcrum. Additionally, the support lever 202 rotates counterclockwise as shown in FIG. 30 with the pin 211 being as the fulcrum. By these operations, the guide lever 201, the support lever 202, and the link lever 203 are located substantially linearly as shown in FIG. 30.

Further, in the third position nearer the insertion direction than the first position and the second position of the peripheral surface as shown in FIG. 25, the optical disk D12 contacts the eject roller 303 disposed at the tip of the third disk guide 43 in the ejection direction, and thereby rotates the third disk guide 43 clockwise as shown in FIG. 30 against a biasing force of the torsion coil spring 215 with the pin 152 being as the fulcrum. Hence, the optical disk D12 is reliably supported by the eject roller 303 with the biasing force of the torsion coil spring 215.

Subsequently, in the fourth position nearer the insertion direction than the first position and the second position of the peripheral surface, the position also being nearer the X direction than the third position, the optical disk D12 contacts the disk roller 403 disposed at the tip of the fourth disk guide 44 in the ejection direction as shown in FIG. 25, and thereby rotates the fourth disk guide 44 counterclockwise as shown in FIG. 30 against the biasing force of the torsion coil spring 216 with the pin 162 being as the fulcrum. Hence, the optical disk D12 is reliably supported by the disk roller 403 with the biasing force of the torsion coil spring 216.

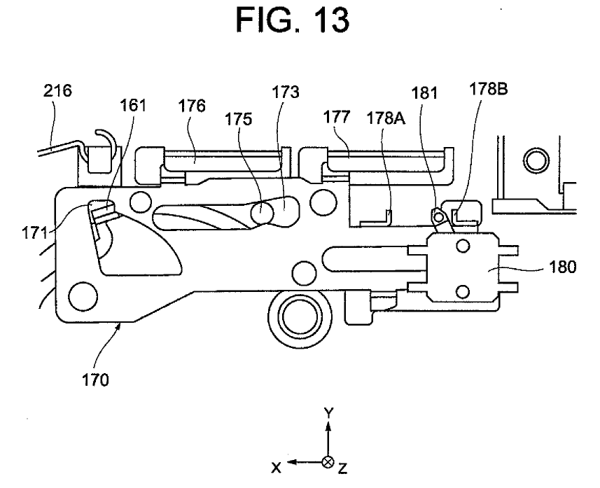

Along with this rotation of the fourth disk guide 44, the protruding portion 161 formed on the disk arm 401 moves to the −X direction from an initial position (for example, refer to FIG. 11) along the hole 143 formed on the chassis 20 (for example, refer to FIG. 32), and thereby the switch plate 170 is moved to the −X direction from an initial position. By this movement of the switch plate 170, the switch lever 181 of the loading switch 180 is switched from an ON-OFF state where the lever is laid down to the X direction (for example, refer to FIG. 13) to an OFF-ON state where the lever is laid down to the −X direction (for example, refer to FIG. 33), thereby starting the loading motor 60. It is to be noted that automatic drawing-in (loading) of the optical disk D12 is not performed until the loading switch 180 is put into the ON state and thereby the loading motor 60 is started.

When the loading motor 60 is started, loading of the optical disk D12 is started. Specifically, a rotary driving force of the loading motor 60 is transmitted to the rack 51 through the worm gear 61, the gear 263, the gear 262, and the gear 261, and the function lever 45 starts to move to the ejection direction from the initial position (for example, refer to FIG. 8). By this movement of the function lever 45, the pin 104 formed on the action lever 101 moves to the cam groove 501 for the optical disk of diameter 12 centimeters from the merging portion 503 of the function lever 45, and thereby the action lever 101 rotates counterclockwise as shown in FIG. 35 with the pin 111 being as the fulcrum. Along with this rotation of the action lever 101, the insertion arm 102 rotates clockwise as shown in FIG. 35 with the pin 109 being as the fulcrum, and the insertion roller 103 moves clockwise as shown in FIG. 35 along the guide rail 23 while supporting the first position of the optical disk D12 with the position being pressed. By this operation, the optical disk D12 is guided to the centering position.

Additionally, by this movement of the function lever 45 to the ejection direction, the control arm 270 rotates counterclockwise with the pin 275 being as the fulcrum as shown in FIG. 37 to thereby move the cam member 47 to the position shown in FIG. 36 (namely, −X direction) from a position shown in FIG. 31. Further, by the movement of the function lever 45, the switching convex portion 145 releases the switch lever 184 of the mode switch 183 (for example, refer to FIGS. 34 and 37), and thereby the switch lever 184 is put into the neutral position (OFF state). Still further, the action lever 101 returns the switch lever 124 to the initial position (for example, refer to FIGS. 11 and 37) by this rotation.

Moreover, the third disk guide 43 is pressed by the optical disk D12 in a state where the eject roller 303 supports the third position of the optical disk D12, and further rotates clockwise as shown in FIG. 35 against the biasing force of the torsion coil spring 216. By this rotation of the third disk guide 43, the pin 223 formed on the eject arm 301 and movably inserted into both the hole 155 and the cam hole 73 moves toward the branch hole 73A.

The fourth disk guide 44 is pressed by the optical disk D12 in a state where the disk roller 403 supports the fourth position of the optical disk D12, and further rotates counterclockwise as shown in FIG. 35 against the biasing force of the torsion coil spring 215. By this rotation of the fourth disk guide 44, the pin 164 formed on the disk arm 401 and movably inserted into both the hole 144 formed on the chassis 20 and the cam hole 71 formed on the cam member 47 moves to the insertion direction, and when the optical disk D12 is guided to the centering position, the pin contacts the edge 72A of the cam hole 71 in the insertion direction. Hence, the disk roller 403 is restrained from moving to the insertion direction when the optical disk D12 is guided to the centering position. As described above, a position of the disk roller 403 is restrained when the optical disk D12 is guided to the centering position, and thereby, even in the case of an optical disk apparatus placed in a vertical attitude, i.e., placed with the X direction side or the −X direction side in the insertion direction being down, the inserted optical disk D12 can be prevented from moving to a lower side of the optical disk apparatus due to its own weight, so that the optical disk apparatus 1 allows for accurate centering of the optical disk D12 regardless of its placed attitude, thus enabling to improve reliability of chucking operation.

Additionally, by the movement of the function lever 45 to the ejection direction, the pin 36B formed on the mechanical deck member 31 relatively moves from a position shown in FIG. 17 to a top position of the inclined hole 52 along the inclined surface 53 thereof as shown in FIG. 39. Simultaneously, by the movement of the cam member 47 to the −X direction, the pin 36A formed on the mechanical deck member 31 relatively moves from a position shown in FIG. 16 to a top position of the inclined hole 79 along an inclined surface thereof as shown in FIG. 38. By these relative movement of the pins 36A and 36B, the traverse unit 30 is elevated, and the damper 33 penetrates into the center hole of the optical disk D12 supported by the insertion roller 103, the guide lever 201, the eject roller 303, and the disk roller 403, and then, the unit is further elevated to the Z direction, and a part of a tip of the damper 33 penetrates into the hole 11A. At this time, the surface around the center hole of the optical disk D12 is pressed against a surface of the concave portion 11B in the −Z direction, and by the resulting reaction force, the damper 33 penetrates to a predetermined position in the center hole of the optical disk D12, and the optical disk D12 is placed on the turntable 34 and then chucked by the damper 33.

After chucking, i.e., after the damper 33 penetrates to the predetermined position in the center hole of the optical disk D12, the function lever 45 further moves to the ejection direction, and by the movement of this function lever 45, the action lever 101 moves clockwise from a chucking position with the pin 111 being as the fulcrum as shown in FIG. 40. Along with this rotation of the action lever 101, the insertion arm 102 rotates counterclockwise as shown in FIG. 40, and the insertion roller 103 moves to the X direction along the guide rail 23 to be spaced apart from the first position of the optical disk D12, and then, it withdraws to the position where the disk can be played.

Additionally, by slide of the cam member 47 to the −X direction along with the movement of the function lever 45 to the ejection direction after chucking, the locking control member 207 rotates counterclockwise with the pin 112 being as the fulcrum as shown in FIG. 43, and thereby further moves the pin 204 formed on the guide lever 201 and inserted into the hole 136 to the −X direction. By the above-described operation, the guide lever 201 further moves to the −X direction as shown in FIG. 40 to be spaced apart from the second position of the optical disk D12, and then, it withdraws to the position where the disk can be played.

Further, by the movement of the function lever 45 to the ejection direction after chucking, the control arm 270 rotates counterclockwise with the pin 275 being as the fulcrum, and thereby further moves the cam member 47 from the position shown in FIG. 36 to the −X direction as shown in FIG. 42. By this movement of the cam member 47, the pin 223 formed on the eject arm 301 moves from a position shown in FIG. 36 to a back side of the branch hole 73A as shown in FIG. 42, and the eject arm 301 rotates clockwise as shown in FIG. 40 against the biasing force of the torsion coil spring 215, and further, the eject roller 303 is spaced apart from the third position of the optical disk D12 and then, withdraws to the position where the disk can be played.

Still further, by the movement of the cam member 47 to the −X direction after chucking, the pin 164 formed on the disk arm 401 moves from a position shown in FIG. 36 to a back side of the branch hole 71A as shown in FIG. 42, and the disk arm 401 rotates counterclockwise as shown in FIG. 40 against the biasing force of the torsion coil spring 216, and further, the disk roller 403 is spaced apart from the fourth position of the optical disk D12 and then, withdraws to the position where the disk can be played.

Additionally, by the movement of the cam member 47 to the −X direction after chucking, the pin 36A formed on the mechanical deck member 31 relatively moves from a position shown in FIG. 38 to the horizontal hole 80 as shown in FIG. 45. Further, by the movement of the function lever 45 to the ejection direction after chucking, the pin 36B formed on the mechanical deck member 31 relatively moves from a position shown in FIG. 38 to the horizontal surface 55 of the inclined hole 52 as shown in FIG. 46. In a manner described above, the chucked optical disk D12 is moved to the position where the disk can be played.

Still further, by the movement of the function lever 45 to the ejection direction after chucking, particularly as shown in FIG. 44, the switching convex portion 146 formed on the function lever 45 contacts the switch lever 184 of the mode switch 183 and then, lays the switch lever 184 down to the ejection direction from the neutral position to be in the play ON state.

As described above, the optical disk D12 is released from the insertion roller 103, the guide lever 201, the eject roller 303, and the disk roller 403 as shown in FIG. 40, and is also placed in the position where it can be played, and further, the mode switch 183 is put into the play ON state, and thereby the disk is put into the state where it can be played.

Subsequently, when the eject button 14 is pushed, an electrical signal is input into a control circuit mounted on the circuit board 50, and a motor drive circuit is controlled by this control circuit, and thus rotation of the spindle motor 32 is stopped. Additionally, the loading motor 60 is rotationally driven in a direction opposite to that in the case of the above-mentioned loading operation, and this rotary driving force of the loading motor 60 is transmitted to the rack 51 through the worm gear 61, the gear 263, the gear 262, and the gear 261, and the function lever 45 moves to the insertion direction. By this movement of the function lever 45, the above-mentioned members, such as the cam member 47 and the control arm 270, move in a direction opposite to that in the case of the above-mentioned loading operation (refer to FIGS. 35 to 37) as shown in FIGS. 47 to 49, and the chucking of the optical disk D12 is released, and then, the first position, the second position, the third position, and the fourth position of the disk are supported by the insertion roller 103, the guide lever 201, the eject roller 303, and the disk roller 403, respectively. When the function lever 45 reaches the eject position, the eject roller 303 pushes the optical disk D12 to the ejection direction by the rotation of the eject arm 301, thus resulting in the ejection of the optical disk D12 from the optical disk apparatus 1. (Refer to FIG. 47). Further, when the function lever 45 moves to the insertion direction and reaches the eject position, the switching convex portion 146 switches the switch lever 186 of the eject switch 185 to put it into the ON state (refer to FIG. 49), and the resulting signal is input into the control circuit, and the motor drive circuit is controlled by this control circuit, and thus the rotation of the loading motor 60 is stopped. It is to be noted that each part returns to the initial position thereof.

Next, specific operations when the user inserts the optical disk D8 of diameter 8 centimeters into the optical disk apparatus in the initial state will be explained with reference to the drawings.

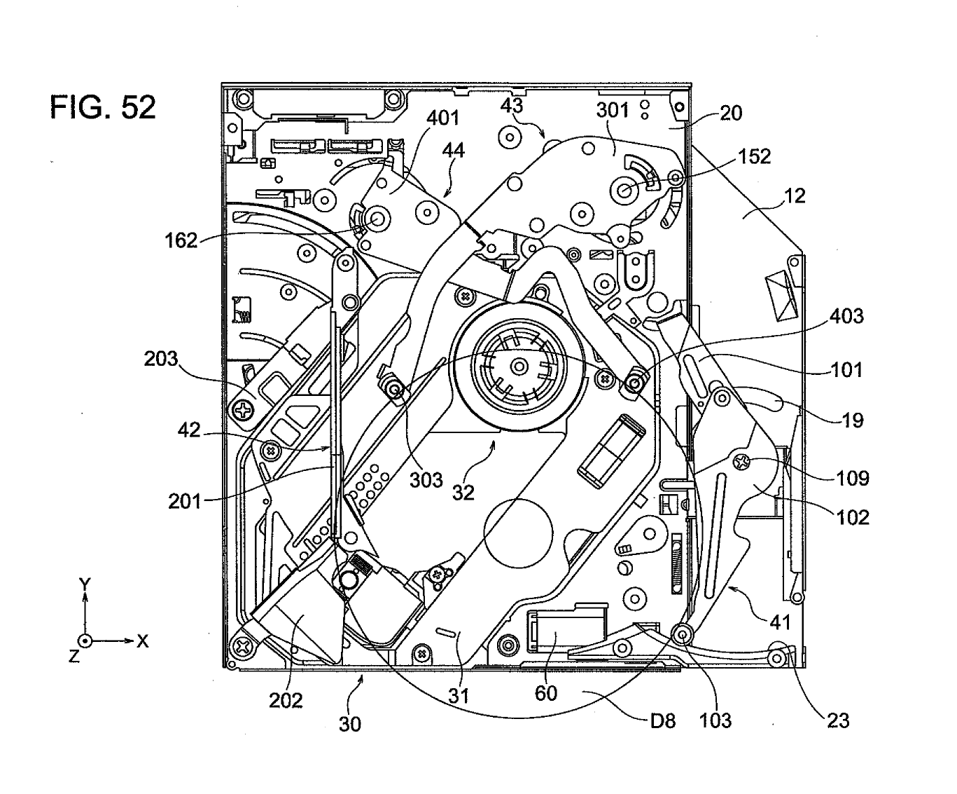

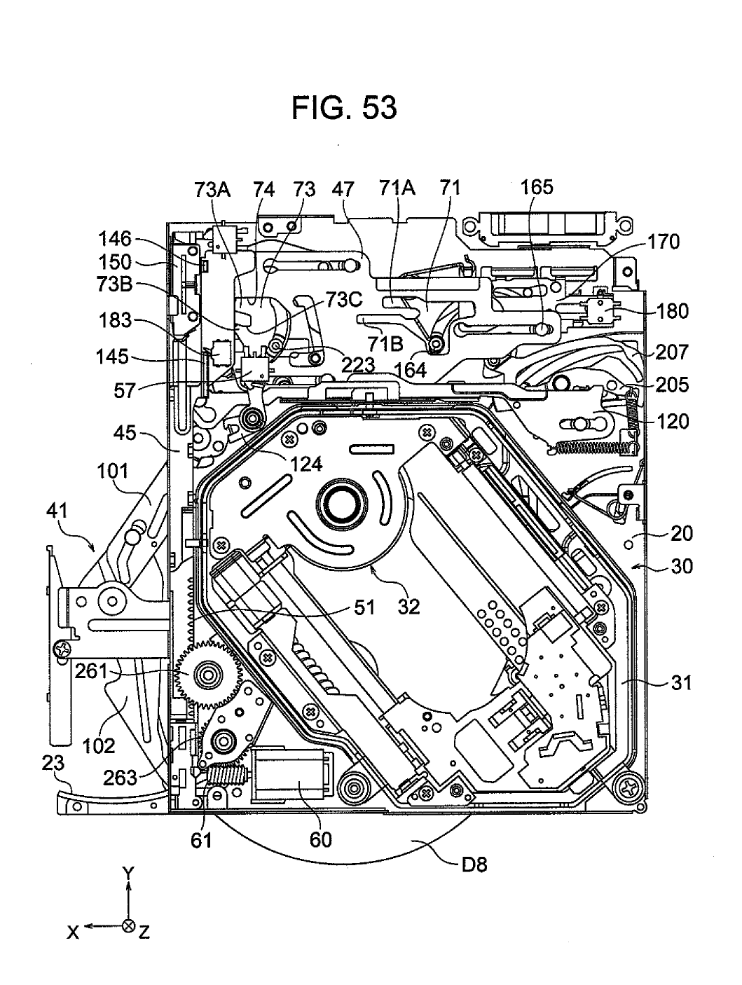

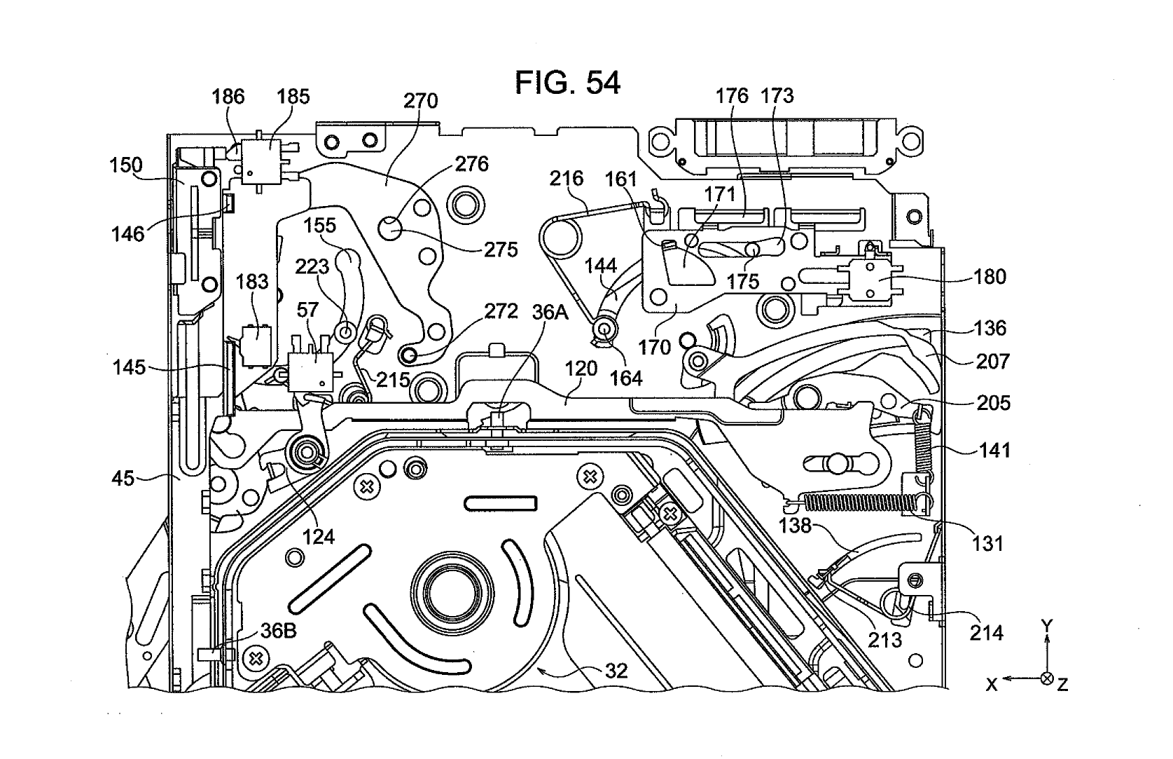

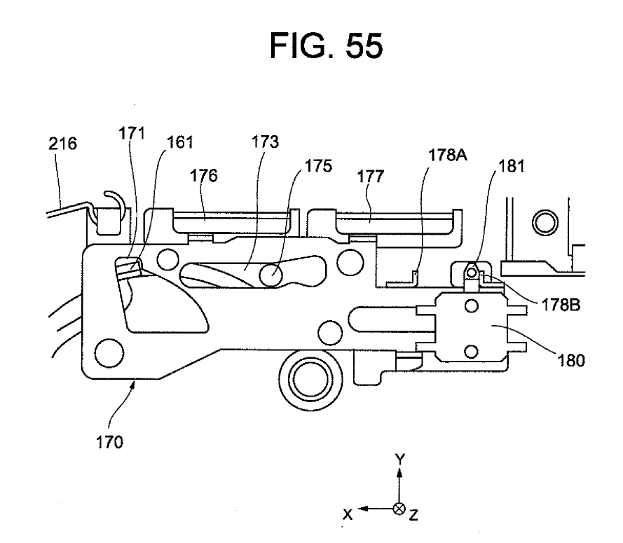

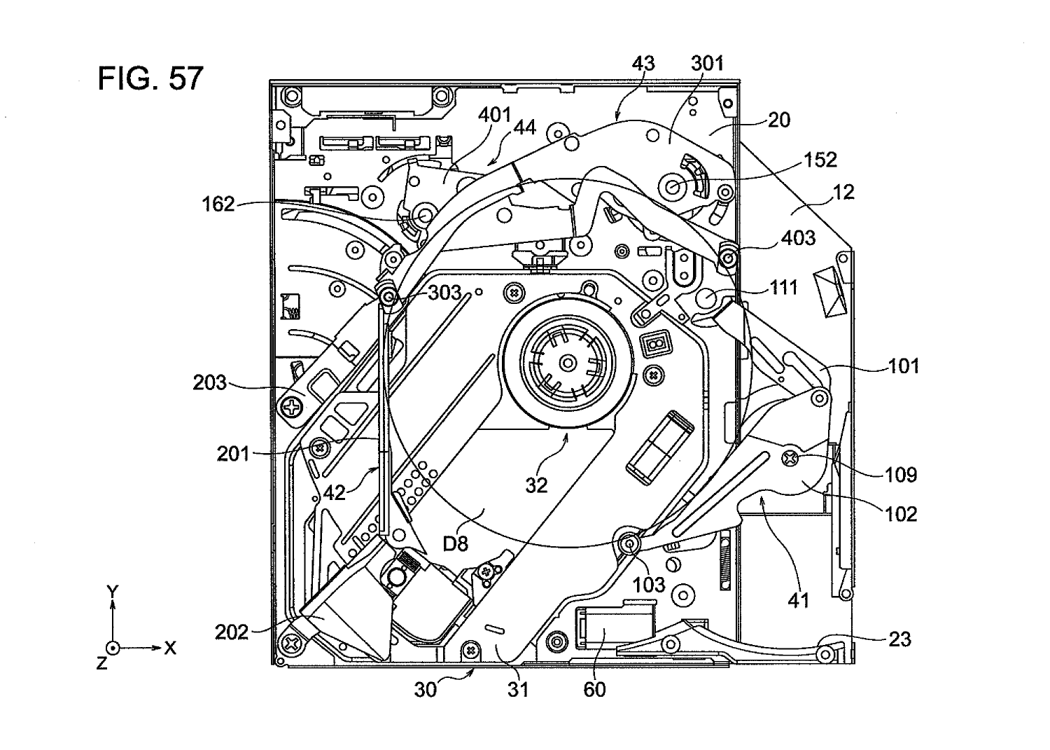

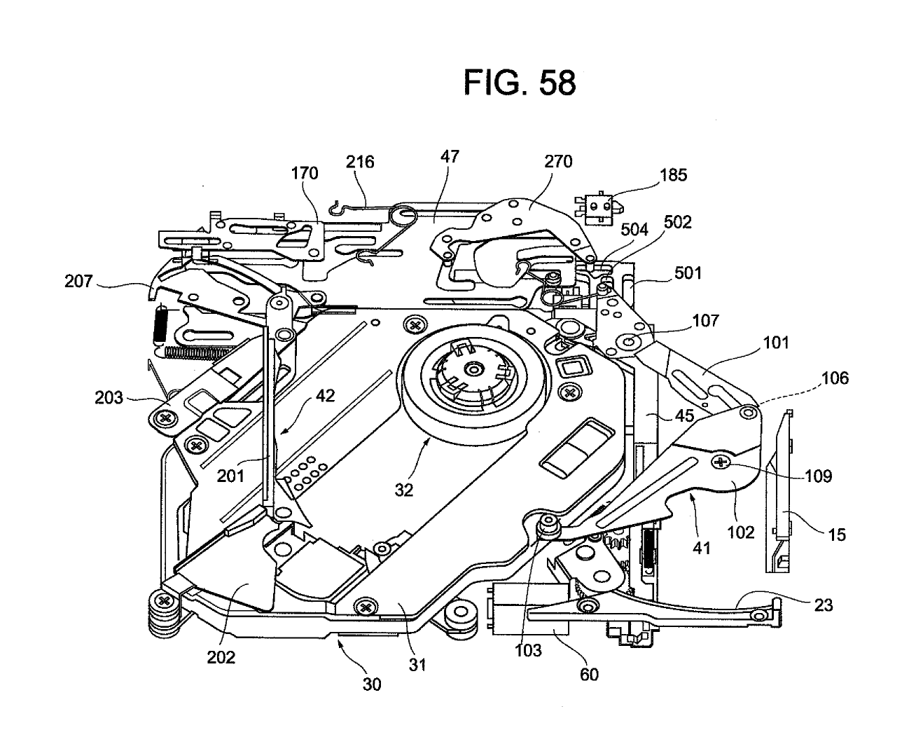

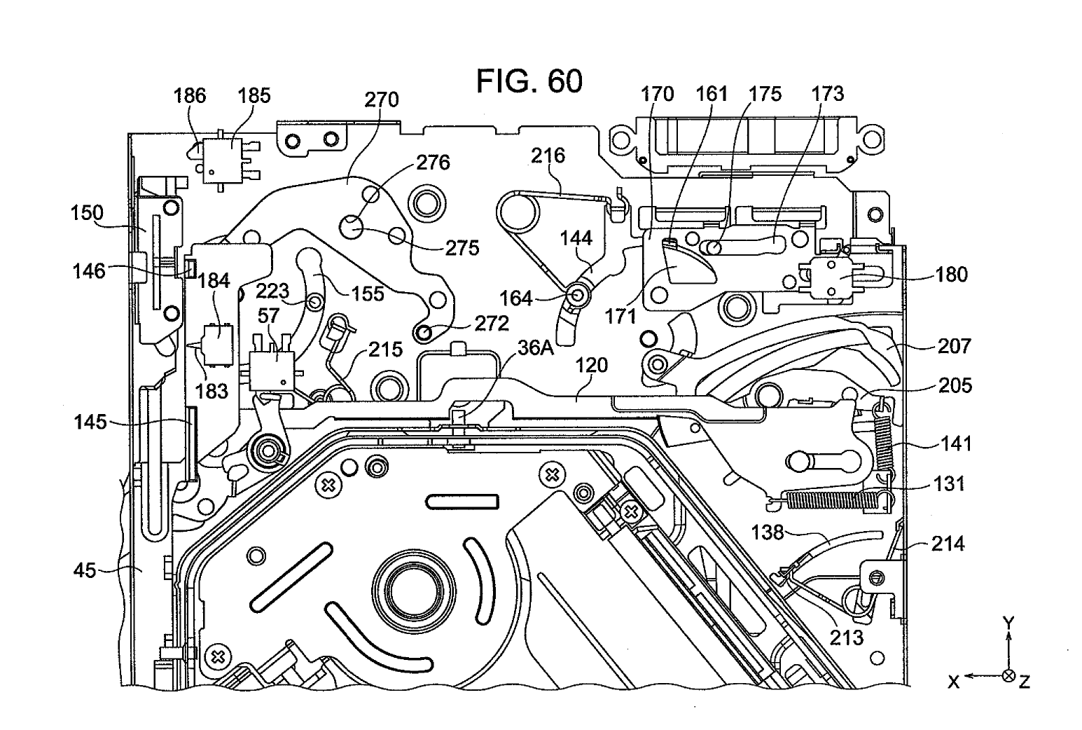

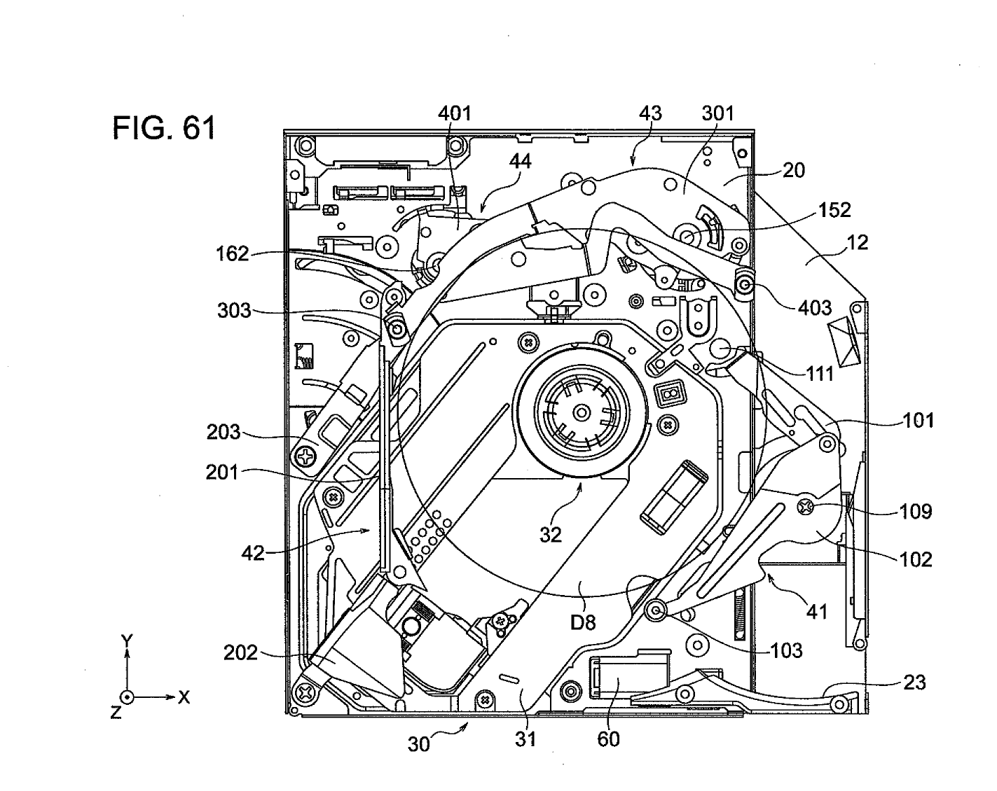

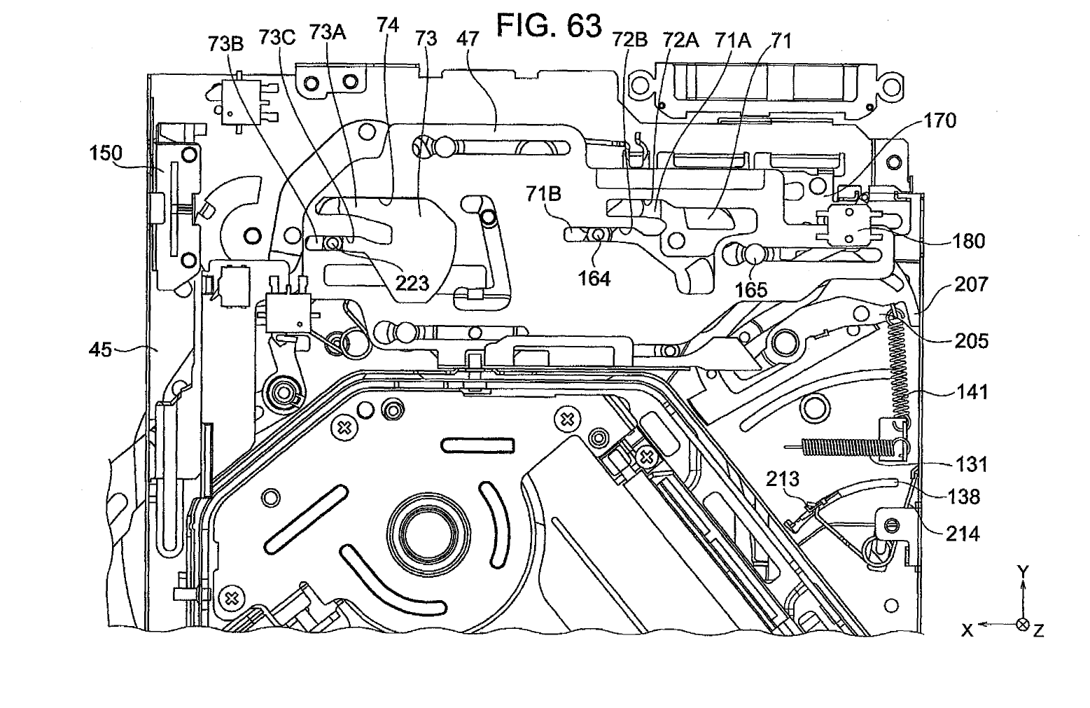

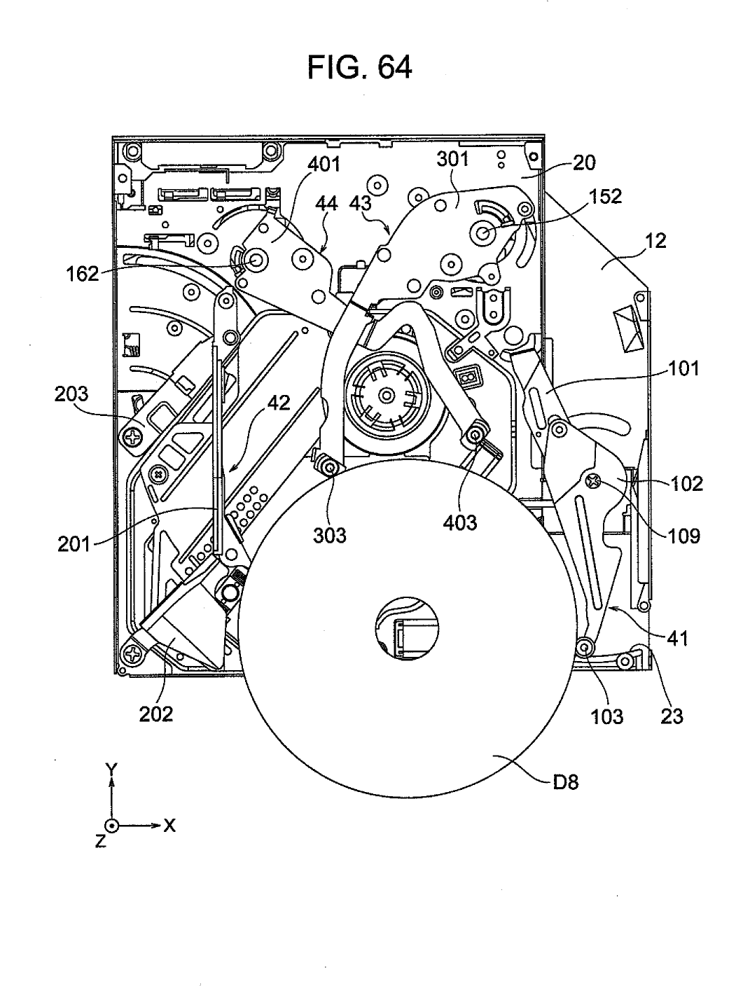

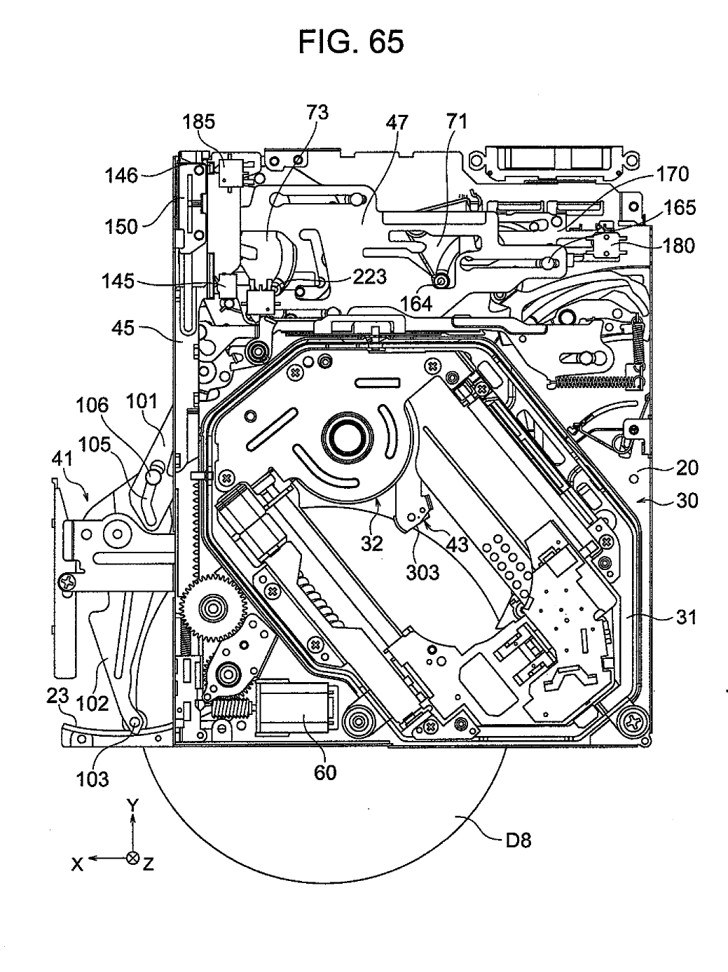

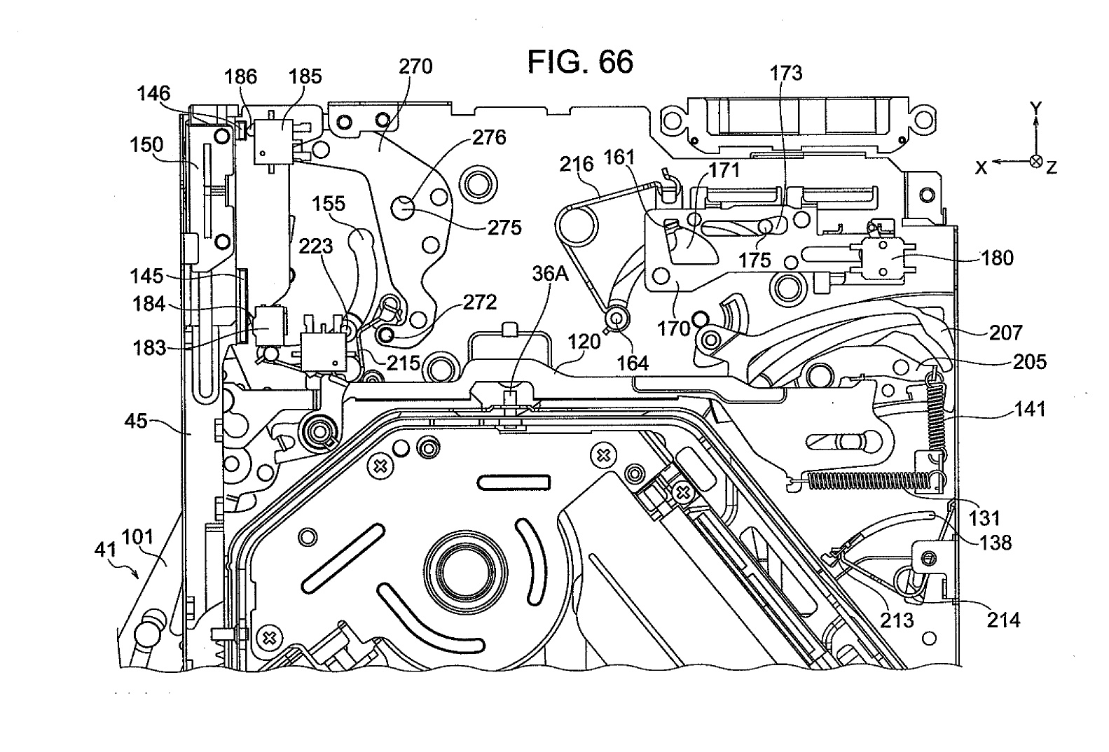

FIG. 51 is a plane view seen from the top without the top cover showing a state where the optical disk of diameter 8 centimeters is being inserted into the optical disk apparatus according to the present embodiment; FIG. 52 is a plane view showing a state where the optical disk is further inserted in the state shown in FIG. 51 to thereby start a loading motor; FIG. 53 is a bottom view showing a state where the bottom case and the circuit board are eliminated from the state shown in FIG. 52; FIG. 54 is a partial enlarged bottom view showing a state where the cam member is eliminated from the state shown in FIG. 53; FIG. 55 is a further enlarged partial bottom view of the state shown in FIG. 54; FIG. 56 is a partial enlarged bottom view of FIG. 59; FIG. 57 is a plane view showing a state where the optical disk is further inserted in the state shown in FIG. 52 and then it is centered; FIG. 58 is a partial exploded perspective view showing a state where a chassis, a third disk guide, and a fourth disk guide are eliminated from the unit shown in FIG. 57; FIG. 59 is a bottom view showing a state where the bottom case and the circuit board are eliminated from the state shown in FIG. 57; FIG. 60 is a partial enlarged bottom view showing a state where the cam member is eliminated from the state shown in FIG. 59; FIG. 61 is a plane view seen from the top without the top cover showing a state where the optical disk of diameter 8 centimeters can be played; FIG. 62 is a bottom view showing a state where the bottom case and the circuit board are eliminated from the state shown in FIG. 61; FIG. 63 is a partial enlarged bottom view of the state shown in FIG. 62; FIG. 64 is a plane view seen from the top without the top cover showing a state where the optical disk of diameter 8 centimeters is ejected; FIG. 65 is a bottom view showing a state where the bottom case and the circuit board are eliminated from the state shown in FIG. 64; and FIG. 66 is a partial enlarged bottom view showing a state where the cam member is eliminated from the state shown in FIG. 65.

It is to be noted that thickness, size, enlargement/reduction rate, etc. of each member in the each drawing are illustrated differently from those of real things in order to clarify the explanation herein. Additionally, symbols are given to parts required for explanation and to main parts in FIGS. 51 to 66 in order to avoid complication, and parts without symbols correspond to equivalent parts illustrated in FIGS. 1 to 24.

When the user inserts the optical disk D8 of diameter 8 centimeters into the housing 10 of the optical disk apparatus 1 in the initial state (for example, refer to FIG. 5) from the opening 13A formed on the front panel 13, the peripheral surface of the optical disk D8 (first position) contacts the insertion roller 103 disposed at the tip of the first disk guide 41 in the ejection direction as shown in FIG. 51. Additionally, the peripheral surface nearer the −X direction than the first position of the optical disk D8 (second position) contacts a vicinity of a tip of the guide lever 201 in the ejection direction, and at the same time, the information recording surface of the optical disk D8 is placed on the support lever 202 to thereby be supported. At this time, as in the case where the optical disk D12 of diameter 12 centimeters is inserted, the second disk guide 42 is locked so as not to move to the −X direction. Further, in the third position nearer the insertion direction than the first position and the second position of the peripheral surface, the optical disk D8 contacts the eject roller 303 disposed at the tip of the third disk guide 43 in the ejection direction. It is to be noted that each member of the optical disk apparatus 1 is still in the initial position thereof at this time.

Next, when the optical disk D8 is further inserted into the housing 10, the first position of the optical disk D8 presses the insertion roller 103, and with this pressing force, the insertion arm 102 rotates counterclockwise as shown in FIG. 51 with the pin 109 being as the fulcrum. Here, in the case of the optical disk D8 of diameter 8 centimeters, the insertion arm 102 rotates only slightly counterclockwise from the initial position thereof, and the action lever 101 does not greatly rotate the switch lever 124, and therefore, the disk discriminating switch 57 is still in the ON state. Additionally, the third position of the optical disk D8 presses the eject roller 303, and the eject arm 301 rotates clockwise from a position shown in FIG. 51 against the biasing force of the torsion coil spring 215 with the pin 152 being as the fulcrum to thereby reach a position shown in FIG. 52. It is to be noted that the optical disk D8 is reliably being supported by the eject roller 303 with the biasing force of the torsion coil spring 215 at this time. Further, as shown in FIG. 52, the fourth position nearer the insertion direction than the first position and the second position of the peripheral end surface of the optical disk D8, and also nearer the X direction than the third position contacts the disk roller 403, and the disk arm 401 rotates counterclockwise as shown in FIG. 52 against the biasing force of the torsion coil spring 216 with the pin 162 being as the fulcrum. Hence, the optical disk D8 is reliably supported by the disk roller 403 with the biasing force of the torsion coil spring 216.

When the disk arm 401 rotates as shown in FIG. 52, the protruding portion 161 formed on the disk arm 401 moves to the −X direction as shown in FIGS. 53 and 54 from the initial position (for example, refer to FIG. 11) along the hole 143 formed on the chassis 20 to thereby move the switch plate 170 to the −X direction from the initial position thereof. By this movement of the switch plate 170, the switch lever 181 of the loading switch 180 is switched from an OFF state (for example, refer to FIG. 13) to a neutral position (OFF-OFF state) as shown in FIG. 55 to thereby start the loading motor 60 under a condition where the optical disk D8 of diameter 8 centimeters is loaded (the disk discriminating switch 57 is in the ON state). It is to be noted that also in this case, automatic drawing-in (loading) of the optical disk D8 is not performed until the loading motor 60 is started.

When the loading motor 60 is started, the function lever 45 starts to move to the ejection direction from an initial position (for example, refer to FIG. 8). By this movement of the function lever 45, the pin 104 formed on the action lever 101 moves to the cam groove 502 for the optical disk of diameter 8 centimeters from the merging portion 503 of the function lever 45 (refer to FIG. 58), and thereby the action lever 101 rotates counterclockwise as shown in FIG. 57 with the pin 111 being as the fulcrum. Along with this rotation of the action lever 101, the insertion arm 102 rotates clockwise as shown in FIG. 57 with the pin 109 being as the fulcrum, and the insertion roller 103 moves clockwise while supporting the first position of the optical disk D8 with the position being pressed. By this operation, the optical disk D8 is guided to the centering position.

Additionally, by the movement of the function lever 45 to the ejection direction, the control arm 270 rotates counterclockwise with the pin 275 being as the fulcrum as shown in FIG. 60 to thereby move the cam member 47 to a position shown in FIG. 59 (namely, −X direction) from a position shown in FIG. 53. Further, by the movement of the function lever 45, the switching convex portion 145 releases the switch lever 184 of the mode switch 183 (for example, refer to FIGS. 59 and 60), and thereby the switch lever 184 is put into the neutral position (OFF-OFF state). Still further, by this movement of the cam member 47, the convex portion 218 formed on the locking control member 207 contacts the inclined surface 49 of the cam member 47, and the locking control member 207 rotates counterclockwise as shown in FIG. 56, and thereby the locking portion 217 contacts the locking lever 205, so that the locking lever 205 is prevented from returning to the position where the pin 204 is locked and thereby the guide lever 201 can move to the −X direction.

Additionally, the third disk guide 43 is pressed by the optical disk D8 in a state where the eject roller 303 supports the third position of the optical disk D8, and further rotates clockwise as shown in FIG. 57 from the position shown in FIG. 52 against the biasing force of the torsion coil spring 216. By this rotation of the third disk guide 43, the pin 223 formed on the eject arm 301 and movably inserted into both the hole 155 and the cam hole 73 contacts the edge 73C of the cam hole 73 in the insertion direction (for example, refer to FIG. 59). Hence, the eject roller 303 is restrained from moving to the insertion direction when the optical disk D8 is guided to the centering position.

The fourth disk guide 44 is pressed by the optical disk D8 in a state where the disk roller 403 supports the fourth position of the optical disk D8, and further rotates counterclockwise as shown in FIG. 57 from the position shown in FIG. 52 against the biasing force of the torsion coil spring 215. By this rotation of the fourth disk guide 44, the pin 164 formed on the disk arm 401 moves to the insertion direction in the hole 144 and the cam hole 71, and then contacts the edge 72B (for example, refer to FIG. 59) for demarcating the insertion direction of the branch hole 71B of the cam hole 71 when the optical disk D8 is guided to the centering position. Hence, the disk roller 403 is restrained from moving to the insertion direction when the optical disk D8 is chucked.

As described above, positions of the eject roller 303 and the disk roller 403 are restrained when the optical disk D8 is guided to the centering position, and thereby, even in the case of the optical disk apparatus placed in the vertical attitude, i.e., placed with the X direction side or the −X direction side in the insertion direction being down, the inserted optical disk D8 can be prevented from moving to the lower side of the optical disk apparatus due to its own weight, so that the optical disk apparatus 1 allows for accurate centering of the optical disk D8 regardless of its placed attitude, thus enabling to improve reliability of chucking operation.

Additionally, by the movement of the function lever 45 to the ejection direction, as in the case of the optical disk D12 of diameter 12 centimeters mentioned above, the optical disk D8 supported by the insertion roller 103, the guide lever 201, the eject roller 303, and the disk roller 403 is placed on the turntable 34, and then chucked by the damper 33.

The function lever 45 further moves to the ejection direction at the time of chucking, and as in the case of the optical disk D12 of diameter 12 centimeters mentioned above, the insertion roller 103, the guide lever 201, the eject roller 303, and the disk roller 403 are spaced apart from the first position, the second position, the third position, and the fourth position of the optical disk D8, respectively as shown in FIG. 61, and then, they withdraw to the position where the disk can be played. Additionally, as in the case of the optical disk D12 of diameter 12 centimeters, the chucked optical disk D8 is moved to the position where the disk can be played, and is thereby put into a state shown in FIGS. 62 and 63. Further, as in the case of the optical disk D12 of diameter 12 centimeters, the switch lever 184 is laid down to the ejection direction from the neutral position to be put into the play ON state, thereby stopping the loading motor 60.

Subsequently, as in the case of the optical disk D12 of diameter 12 centimeters, when the eject button 14 is pushed, the optical disk D8 is moved to the ejection direction as shown in FIGS. 64 to 66, and then the rotation of the loading motor 60 is stopped.

It is to be noted that in the present embodiment, a case is described where the disk roller 403 is restrained from moving to the insertion direction by the cam member 47 when the optical disk D12 of diameter 12 centimeters is guided to the centering position, but the invention is not limited to this, and in the case of the optical disk D12 of diameter 12 centimeters as well as that of the optical disk D8 of diameter 8 centimeters, the eject roller 303 and the disk roller 403 may be restrained from moving to the insertion direction by the cam member 47, or only the eject roller 303 may be restrained from moving to the insertion direction by the cam member 47.

Additionally, in the present embodiment, a case is described where the eject roller 303 and the disk roller 403 are restrained from moving to the insertion direction by the cam member 47 when the optical disk D8 of diameter 8 centimeters is guided to the centering position, but the invention is not limited to this, and in the case of the optical disk D8 of diameter 8 centimeters as well as that of the optical disk D12 of diameter 12 centimeters, the disk roller 403 may be restrained from moving to the insertion direction by the cam member 47, or only the eject roller 303 may be restrained from moving to the insertion direction by the cam member 47.

It should be further understood by those skilled in the art that although the foregoing description has been made on embodiments of the invention, the invention is not limited thereto and various changes and modifications may be made without departing from the spirit of the invention and the scope of the appended claims.

1. An optical disk apparatus for recording information onto an optical disk and reproducing the information from the optical disk while chucking the optical disk at a centering position after the optical disk is inserted into a case in an insert direction and guided to the centering position, comprising:
a chassis arranged in the case,
a first disk guide arranged on the chassis to support a first portion of the optical disk to be guided toward the centering position,
a second disk guide arranged on the chassis to support a second position of the optical disk distant from the first position to be guided toward the centering position,
a third disk guide arranged on the chassis to support a third portion of the optical disk distant in the insert direction from the first portion of the optical disk guided by the first and second disk guides so that the optical disk is guided toward the centering position by the third disk guide with the first and second disk guides,
a fourth guide arranged on the chassis to support a fourth portion of the optical disk distant in the insert direction from the second portion of the optical disk guided by the first and second disk guides and distant from the third portion so that the optical disk is guided toward the centering position by the fourth disk guide with the first and second disk guides, and
a cam member arranged on the chassis,
wherein the cam member engages with at least one of the third and fourth disk guides to be restrained from moving in the optical disk insert direction when the optical disk reaches the centering position, and releases the restraint of the at least one of the third and fourth disk guides when the optical disk is chucked.

2. The optical disk apparatus according to claim 1, wherein when the optical disk is taken into or out of the chassis, the cam member is movable along a planer surface of the chassis in corresponding one of directions perpendicular to the insert direction so that the movement of the cam member makes the cam member engage with the at least one of the third and fourth disk guides, and subsequently releases the engagement of the cam member with the at least one of the third and fourth disk guides when the optical disk is chucked.

3. The optical disk apparatus according to claim 2, wherein the cam member makes the optical disk be chucked and releases the optical disk from being chucked in accordance with the movement of the cam member.

4. The optical disk apparatus according to claim 1, wherein the third disk guide is rotatable with respect to the chassis to guide the optical disk toward the centering position, the cam member includes a hole capable of receiving a protrusion of the third disk guide movably with the rotation of the third disk guide so that the protrusion of the third disk guide engages with an edge of the hole of its side extending in the insert direction from its central position when the optical disk reaches the centering position.

5. The optical disk apparatus according to claim 1, wherein the fourth disk guide is rotatable with respect to the chassis to guide the optical disk toward the centering position, the cam member includes a hole capable of receiving a protrusion of the fourth disk guide movably with the rotation of the fourth disk guide so that the protrusion of the fourth disk guide engages with an edge of the hole of its side extending in the insert direction from its central position when the optical disk reaches the centering position.

6. The optical disk apparatus according to claim 4, wherein the apparatus is capable of recording the information onto and reproducing the information from each of the optical disk having a first diameter and another optical disk having a second diameter smaller than the first diameter, and
the hole has a first branch hole for receiving the protrusion when the optical disk is chucked, and a second branch hole for receiving the protrusion when the another optical disk is chucked,
so that the protrusion engages with at least one of an edge of the first branch hole of its side extending in the insert direction from its central position and another edge extending from the edge when the optical disk is chucked, and with at least one of an edge of the second branch hole of its side extending in the insert direction from its central position and another edge extending from the edge when the another optical disk is chucked.

7. The optical disk apparatus according to claim 5, wherein the apparatus is capable of recording the information onto and reproducing the information from each of the optical disk having a first diameter and another optical disk having a second diameter smaller than the first diameter, and
the hole has a first branch hole for receiving the protrusion when the optical disk is chucked, and a second branch hole for receiving the protrusion when the another optical disk is chucked,
so that the protrusion engages with at least one of an edge of the first branch hole of its side extending in the insert direction and another edge extending from the edge when the optical disk is chucked, and with at least one of an edge of the second branch hole of its side extending in the insert direction from its central position and another edge extending from the edge when the another optical disk is chucked.

8. The optical disk apparatus according to claim 2, wherein the second disk guide is movable in a direction perpendicular to the insert direction to guide the optical disk toward the centering position, and
the chassis has a lock member for locking the movement of the second disk guide so that the lock member locks the movement of the second disk guide and releases such locking of the second disk guide in accordance with at least one of the movement of the first disk guide and the movement of the cam member.
